(19) United States
(12) Patent Application Publication
(10) Pub. No.: US 2026/0070213 A1
(43) Pub. Date: Mar. 12, 2026

(54) Transport System and Automatic Teaching Method

(71) Applicant: DMG MORI CO., LTD., NARA (JP)

(72) Inventors: Tomoaki YODA, NARA (JP); Koji NAKAGAWA, NARA (JP); Hiroyoshi MORI, NARA (JP); Yusuke SAKAI, NARA (JP); Hirofumi MORITA, NARA (JP)

(73) Assignee: DMG MORI CO., LTD., NARA (JP)

(21) Appl. No.: 19/249,940

(22) Filed: Jun. 25, 2025

(30) Foreign Application Priority Data
Jun. 28, 2024 (JP) 2024-105161

(51) Int. Cl. B25J 9/16; B25J 9/00; B25J 13/08

(52) U.S. Cl. CPC B25J 9/1612; B25J 9/0081; B25J 9/1687; B25J 13/088

(57) ABSTRACT

A transport system includes a robot control unit. The robot control unit operates a robot to detect positions of three portions of a pallet stocker distant from one another and generates a user coordinate system in the pallet stocker based on the detected positions. The robot control unit operates the robot to detect a position of a specific portion of a shelf plate and calculates a position of a grip portion of the pallet in the user coordinate system based on the detected position and a positional relationship between the specific portion and the grip portion with the pallet being placed on the shelf plate.

### CROSS REFERENCE TO RELATED APPLICATIONS

This nonprovisional application is based on Japanese Patent Application No. 2024-105161 filed on Jun. 28, 2024 with the Japan Patent Office, the entire contents of which are hereby incorporated by reference.

### BACKGROUND OF THE INVENTION

### Field of the Invention

The present invention relates to a transport system and an automatic teaching method.

### Description of the Background Art

For example, Japanese Patent Laying-Open No. 2017-102825 discloses a combined system including a machine tool having a workpiece fixing jig integrally movable with a table, a workpiece stocker that stores a workpiece, and a robot system having a robot that supplies or takes out the workpiece to or from the workpiece fixing jig and the workpiece stocker.

### SUMMARY OF THE INVENTION

As disclosed in Japanese Patent Laying-Open No. 2017-102825, a transport system is known that uses a robot to transport various transport objects. In such a transport system, a teaching operation is required to teach the robot on its movement, and a reduction in the labor required for the teaching operation is desired.

An object of the present invention is to provide a transport system and an automatic teaching method that can reduce the labor required for a teaching operation of a robot.

A transport system according to the present invention includes: a pallet stocker for storing a pallet, the pallet stocker having a shelf plate on which the pallet is placed; a robot having a hand that grips a grip portion of the pallet, the robot transporting the pallet; and a robot control unit that controls the robot. The robot control unit operates the robot to detect positions of three portions of the pallet stocker distant from one another and generates a user coordinate system in the pallet stocker based on the detected positions of the three portions. The robot control unit operates the robot to detect a position of a specific portion of the shelf plate and calculates a position of the grip portion in the user coordinate system based on the detected position of the specific* portion and a positional relationship between the specific portion and the grip portion with the pallet being placed on the shelf plate.

An automatic teaching method according to the present invention is an automatic teaching method in a transport system. The transport system includes: a pallet stocker for storing a pallet, the pallet stocker having a shelf plate on which the pallet is placed; and a robot having a hand that grips a grip portion of the pallet, the robot transporting the pallet. The automatic teaching method includes: operating the robot to detect positions of three portions of the pallet stocker distant from one another and generating a user coordinate system in the pallet stocker based on the detected positions of the three portions; and operating the robot to detect a position of a specific portion of the shelf plate and calculating a position of the grip portion in the user coordinate system based on the detected position of the specific portion and a positional relationship between the specific portion and the grip portion with the pallet being placed on the shelf plate.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a top view of a transport system in an embodiment of the present invention.

FIG. 2 is a simplified top view of the transport system in FIG. 1.

FIG. 3 is a perspective view showing the relationship of a pallet, a workpiece hand, a shelf plate, and a teaching hand to a master hand.

FIG. 4 is a perspective view of the master hand.

FIG. 5 is another perspective view of the master hand.

FIG. 6 is a view for illustrating a structure of the master hand.

FIG. 7 is a perspective view of a pallet stocker in FIG. 1.

FIG. 8 is a perspective view of the pallet stocker in the area enclosed by the chain double-dashed line VIII in FIG. 7.

FIG. 9 is a block diagram showing a control system of the transport system in FIG. 1.

FIG. 10 is a top view showing a first step of workpiece machining using a workpiece stocker.

FIG. 11 is a top view showing a second step of workpiece machining using the workpiece stocker.

FIG. 12 is a top view showing a third step of workpiece machining using the workpiece stocker.

FIG. 13 is a top view showing a fourth step of workpiece machining using the workpiece stocker.

FIG. 14 is a top view showing a fifth step of workpiece machining using the workpiece stocker.

FIG. 15 is a top view showing a sixth step of workpiece machining using the workpiece stocker.

FIG. 16 is a top view showing a first step of workpiece machining using a setup station.

FIG. 17 is a top view showing a second step of workpiece machining using the setup station.

FIG. 18 is a top view showing a third step of workpiece machining using the setup station.

FIG. 19 is a top view showing a fourth step of workpiece machining using the setup station.

FIG. 20 is a top view showing a fifth step of workpiece machining using the setup station.

FIG. 21 is a top view showing a first step of loading a pallet to the pallet stocker.

FIG. 22 is a top view showing a second step of loading the pallet to the pallet stocker.

FIG. 23 is a top view showing a third step of loading the pallet to the pallet stocker.

FIG. 24 is a flowchart showing an overall flow of a robot teaching operation.

FIG. 25 is a front view of the pallet stocker during automatic teaching.

FIG. 26 is a front view showing the positional relationship between a reference hole and a first grip portion of the pallet stored in the workpiece stocker.

FIG. 27 is a block diagram showing a control system for automatic teaching.

FIG. 28 is a perspective view showing how automatic teaching is performed for generation of a user coordinate system.

FIG. 29 shows a user coordinate system generation screen in a display unit.

FIG. 30 is a perspective view showing how automatic teaching for grip position setting is performed.

FIG. 31 shows a grip position setting screen on the display unit.

FIG. 32 is a flowchart showing a flow of the steps of automatic teaching for generation of the user coordinate system.

FIG. 33 is a flowchart showing a flow of the steps of automatic teaching for grip position setting.

FIG. 34 is a side view showing how manual teaching is performed.

### DESCRIPTION OF THE PREFERRED EMBODIMENTS

An embodiment of the present invention will be described with reference to the drawings. In the drawings referred to below, the same or corresponding components have the same reference signs allotted.

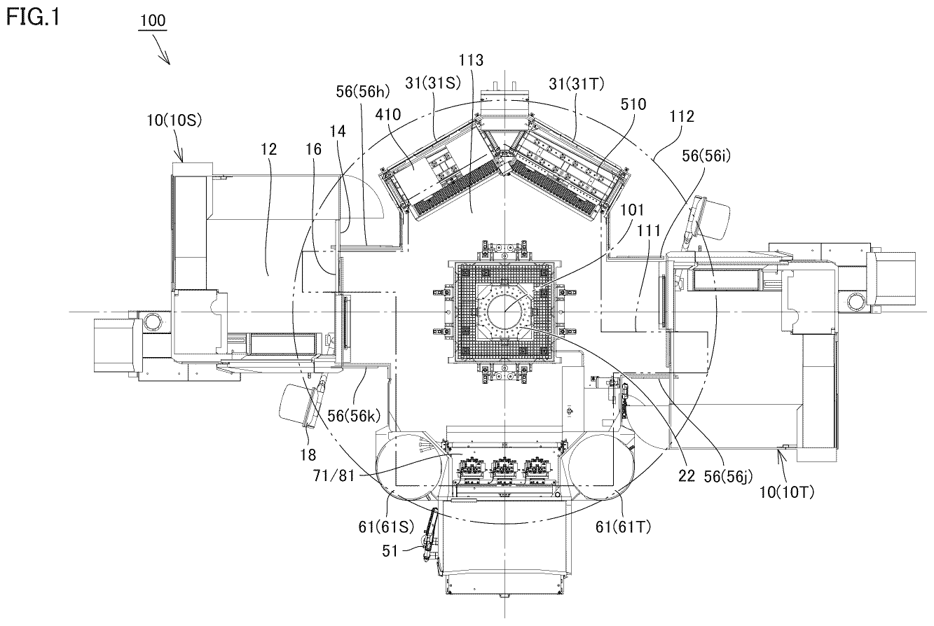

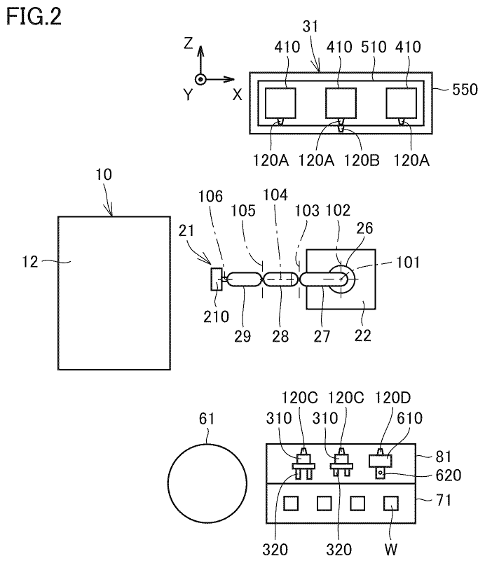

FIG. 1 is a top view of a transport system in an embodiment of the present invention. FIG. 2 is a simplified top view of the transport system in FIG. 1.

Referring to FIGS. 1 and 2, a transport system 100 in the present embodiment has a robot 21 and a robot base 22.

In a typical example, robot 21 is a 6-axis articulated robot. Robot 21 has a base 26, a first arm 27, a second arm 28, a hand attachment portion 29, and a master hand 210.

Robot base 22 is a support stand that supports robot 21 and is fixed to the floor of a plant or the like. Robot base 22 is made of metal. Base 26 is connected to robot base 22 to be rotatable about a swivel center axis 101. Swivel center axis 101 is an imaginary straight line corresponding to the swivel center of robot 21 and extends in the upward-downward direction.

First arm 27 is attached to base 26. First arm 27 is pivotable about a pivot center axis 102 disposed at the attachment portion (joint) of first arm 27 to base 26. Second arm 28 is attached to first arm 27. Second arm 28 is pivotable about a pivot center axis 103 disposed at the attachment portion (joint) of second arm 28 to first arm 27, and can rotate hand attachment portion 29 about a rotation center axis 104 along second arm 28. Hand attachment portion 29 is attached to second arm 28. Hand attachment portion 29 is pivotable about a pivot center axis 105 disposed at the attachment portion (joint) of hand attachment portion 29 to second arm 28, and can rotate master hand 210 about a rotation center axis 106 along hand attachment portion 29.

Master hand 210 is attached to hand attachment portion 29 as an end effector. Master hand 210 is attached to second arm 28 to be pivotable about pivot center axis 105. Master hand 210 is attached to second arm 28 via hand attachment portion 29. Second arm 28 is attached to first arm 27 to be pivotable about pivot center axis 103.

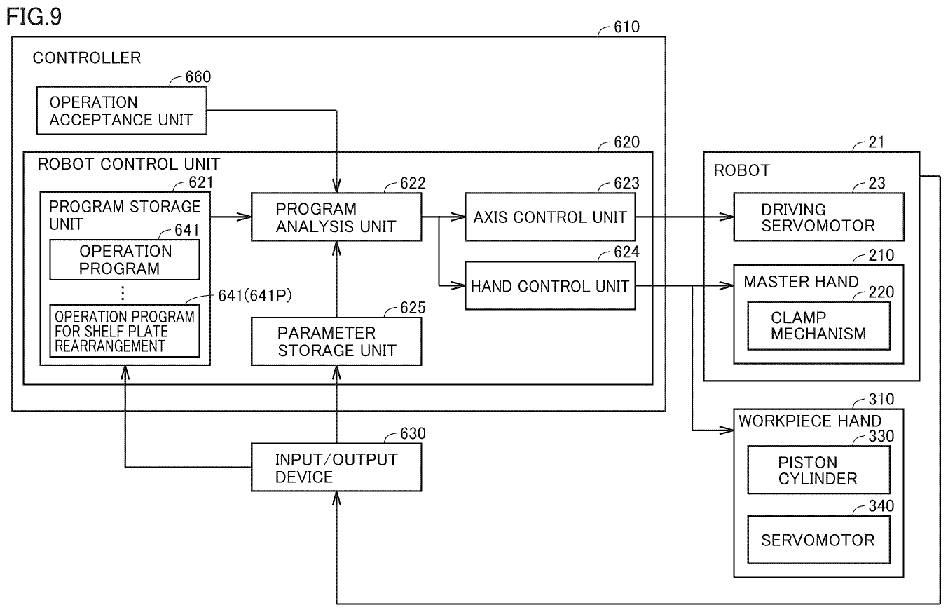

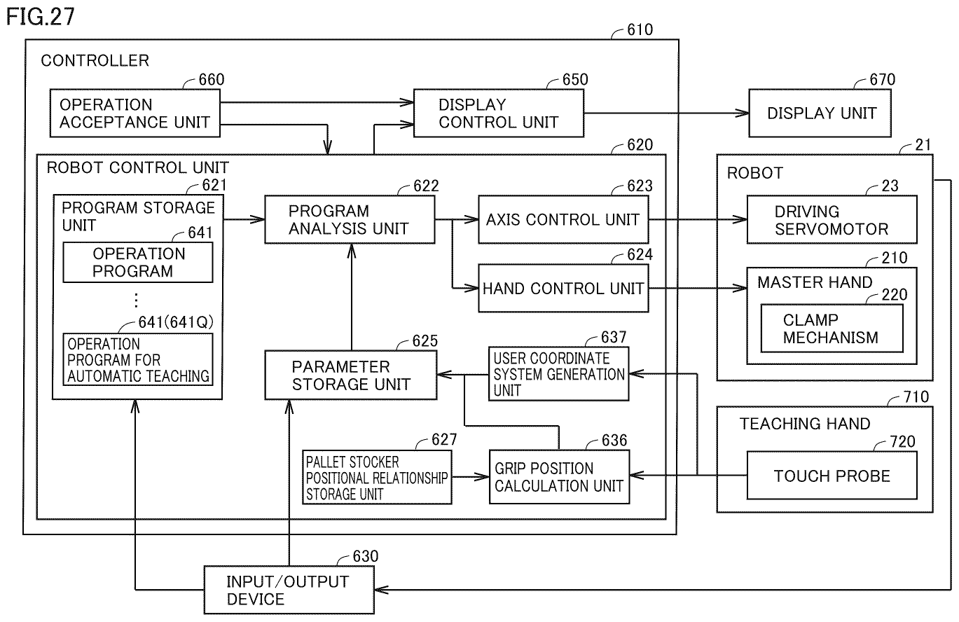

Robot 21 further has a plurality of driving servomotors 23 (see FIGS. 9 and 27, which will be referred to later) for causing base 26, first arm 27, second arm 28, hand attachment portion 29, and master hand 210 to operate respectively about the above-described axes (swivel center axis 101, pivot center axis 102, pivot center axis 103, rotation center axis 104, pivot center axis 105, and rotation center axis 106).

In FIG. 1, the area in which master hand 210 moves (the operating area of master hand 210) in transport system 100 is indicated by a chain double-dashed line 111. In addition, the maximum area in which master hand 210 can move is indicated by a chain double-dashed line 112, which extends in an arc shape about swivel center axis 101.

Transport system 100 further has a machine tool 10 (10S, 10T), a pallet stocker 31 (31S, 31T), a workpiece stocker 71, a hand stocker 81, and a setup station 61 (61S, 61T).

Machine tool 10 (10S, 10T), pallet stocker 31 (31S, 31T), workpiece stocker 71, hand stocker 81, and setup station 61 (61S, 61T) are provided around robot base 22. Machine tool 10 (10S, 10T), pallet stocker 31 (31S, 31T), workpiece stocker 71, hand stocker 81, and setup station 61 (61S, 61T) are located side by side along the circumferential direction of swivel center axis 101. In the top view shown in FIG. 1, at least part of each device such as machine tool 10 (10S, 10T), pallet stocker 31 (31S, 31T), workpiece stocker 71, hand stocker 81, and setup station 61 (61S, 61T) overlaps the operating area of master hand 210 which is indicated by chain double-dashed line 111.

The robot in the present invention is not limited to the above-described 6-axis articulated robot, and may be, for example, a robot (gantry loader) capable of moving a transport object in the directions of three axes mutually orthogonal to one another. In addition, the machine tool, pallet stocker, workpiece stocker, hand stocker, and setup station may be disposed side by side linearly.

Machine tool 10 is a machining center that performs workpiece machining by bringing a rotating tool into contact with the workpiece. Machine tool 10 is a numerically controlled (NC) machine tool in which various operations for workpiece machining are automated through numerical control by a computer.

Machine tool 10 may be a multi-tasking machine having a turning function using a fixing tool and a milling function using a rotating tool, or an additive manufacturing (AM)/subtractive manufacturing (SM) hybrid machine capable of additive manufacturing of workpieces and subtractive manufacturing of workpieces. Machine tool 10S and machine tool 10T may be machine tools of the same type or machine tools of different types.

Machine tool 10 has a cover body 14. Cover body 14 forms the external appearance of machine tool 10 and also defines a machining area 12. Machining area 12 is the space in which the workpiece is machined, and is hermitically sealed by cover body 14 so as to prevent foreign matter such as chips or cutting oil associated with workpiece machining from leaking out of the machining area.

Cover body 14 has an opening 16. Robot 21 transports a transport object such as a workpiece W or a pallet 410 to machining area 12 through opening 16. Opening 16 has a door or a shutter that is openable and closable.

In machining area 12, a tool spindle for rotating a tool, a table for holding pallet 410, and the like are provided.

Machine tool 10 further has an operation panel 18. Operation panel 18 includes a controller that controls an operation of machine tool 10, a display unit (display) for displaying various types of information related to machining, and an operation unit that accepts various operations for machine tool 10.

Machine tool 10S and machine tool 10T are positioned so as to face each other with robot base 22 in between. Machine tool 10S and machine tool 10T are provided at angular positions offset by 180° in the circumferential direction about swivel center axis 101.

Pallet stocker 31 is a device for storing pallet 410. Pallet stocker 31 is provided between machine tool 10S and machine tool 10T in the circumferential direction about swivel center axis 101. Pallet stocker 31S and pallet stocker 31T are provided adjacent to each other in the circumferential direction about swivel center axis 101.

Workpiece stocker 71 is a device for storing workpiece W. Workpiece stocker 71 has a shelf structure on which workpiece W can be placed. Hand stocker 81 is a device for storing various hands, such as a workpiece hand 310 and a teaching hand 710, which will be described later. Hand stocker 81 has a shelf structure on which various hands can be placed.

Workpiece stocker 71 and hand stocker 81 are provided between machine tool 10S and machine tool 10T in the circumferential direction about swivel center axis 101. Workpiece stocker 71 and hand stocker 81 are positioned so as to face pallet stocker 31 (31S, 31T) with robot base 22 in between. Workpiece stocker 71 and hand stocker 81 are provided side by side in the upward-downward direction.

Setup station 61 is a device mainly for attaching and detaching workpiece W to and from pallet 410. Setup station 61 is equipped with a pallet placement base (not shown) on which pallet 410 can be placed. Setup station 61 is provided between workpiece stocker 71, hand stocker 81 and machine tool 10 in the circumferential direction about swivel center axis 101. Setup station 61 is provided adjacent to workpiece stocker 71 and hand stocker 81 in the circumferential direction about swivel center axis 101.

Setup station 61S and setup station 61T are provided on the opposite sides of workpiece stocker 71 and hand stocker 81 in the circumferential direction about swivel center axis 101.

The number of the devices such as machine tools 10, pallet stockers 31, workpiece stockers 71, hand stockers 81, and setup stations 61 included in transport system 100 is not particularly limited.

Transport system 100 further has a plurality of fences 56 (56h, 56i, 56j, 56k). Fences 56 rise from the floor of a plant or the like. In the top view shown in FIG. 1, fence 56h extends between machine tool 10S and pallet stocker 31S. In the top view shown in FIG. 1, fence 56i extends between pallet stocker 31T and machine tool 10T. In the top view shown in FIG. 1, fence 56j extends between machine tool 10T and setup station 61T. In the top view shown in FIG. 1, fence 56k extends between setup station 61S and machine tool 10S.

Robot 21 is disposed in a space 113 surrounded by the plurality of fences 56 (56h, 56i, 56j, 56k), machine tools 10 (10S, 10T), pallet stockers 31 (31S, 31T), workpiece stocker 71, hand stocker 81, and setup stations 61 (61S, 61T). The operating area of master hand 210, indicated by chain double-dashed line 111, is included in space 113.

The operator cannot access pallet stocker 31 from outside of space 113. The operator can load pallet 410 to pallet stocker 31 and retrieve pallet 410 from pallet stocker 31 through setup station 61. The operator can access workpiece stocker 71 and hand stocker 81 from outside of space 113. Through workpiece stocker 71, the operator can load a workpiece W yet to be machined to transport system 100 and retrieve a machined workpiece W′ from transport system 100. Through hand stocker 81, the operator can load various hands to transport system 100 and retrieve the hands from transport system 100.

Transport system 100 further has a transport operation panel 51. Transport operation panel 51 includes a controller 610 that controls an operation of robot 21, a display unit 670 for displaying various types of information related to transport by robot 21, and an operation unit that accepts various operations for robot 21 (see FIGS. 9 and 27, which will be referred to later). In the present embodiment, display unit 670 is configured as a touch panel display that can be operated by the operator, and is in charge of some of the functions of the operation unit. The operation unit may be configured as various buttons that can be pressed, numeric keys that can receive input of numbers, a dial, or the like.

Transport operation panel 51 is attached to workpiece stocker 71 and hand stocker 81. The position at which transport operation panel 51 is provided is not particularly limited.

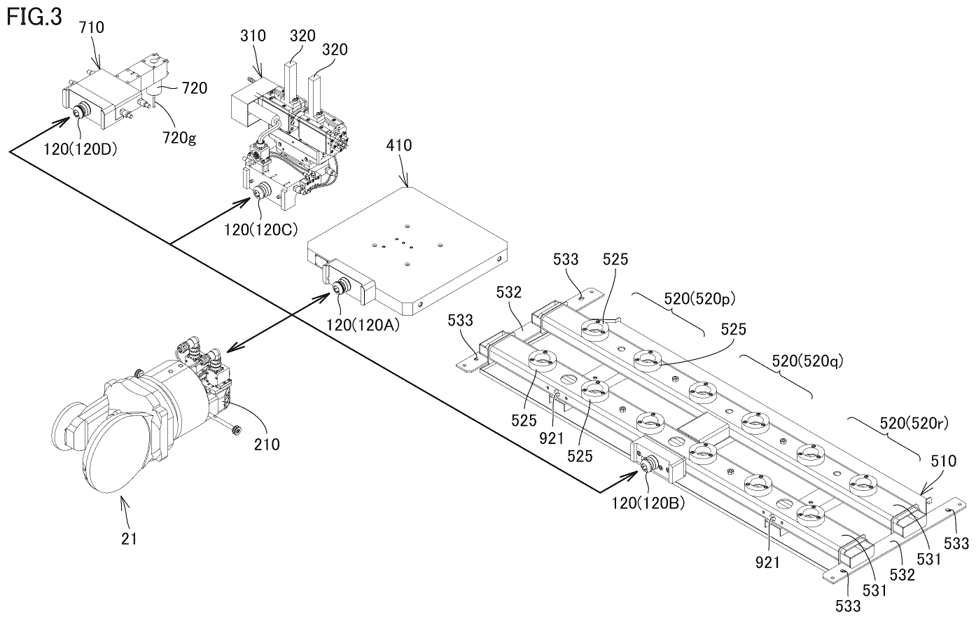

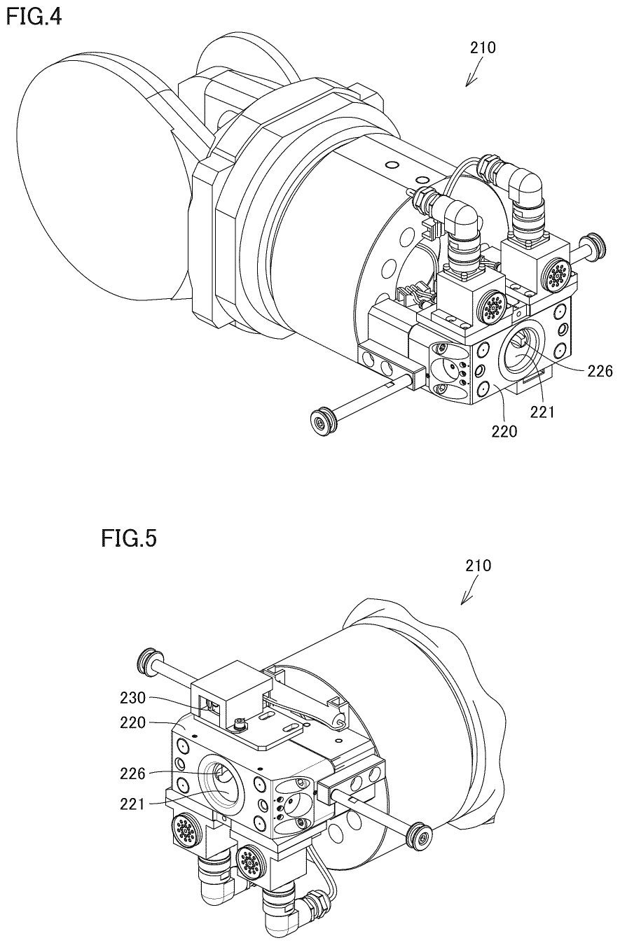

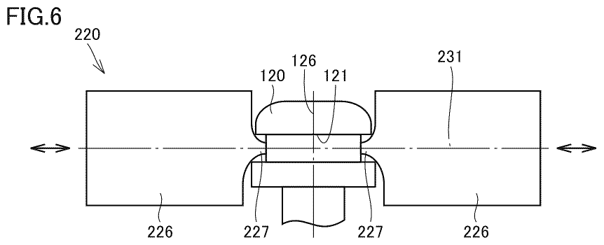

FIG. 3 is a perspective view showing the relationship of the pallet, workpiece hand, shelf plate, and teaching hand to the master hand. FIGS. 4 and 5 are perspective views of the master hand. FIG. 6 is a view for illustrating the structure of the master hand.

Referring to FIGS. 3 to 6, master hand 210 has a clamp mechanism 220. Clamp mechanism 220 is configured to be operable between a clamped state in which a grip portion 120 is held and an unclamped state in which grip portion 120 is released.

As shown in FIGS. 4 to 6, grip portion 120 has a grip shape that is centered on a central axis 126. Grip portion 120 has a groove portion 121. Groove portion 121 has a groove shape that is recessed from the outer circumferential surface of grip portion 120 and goes around central axis 126.

Clamp mechanism 220 has the external appearance of a block body. Clamp mechanism 220 has a grip insertion hole 221. Grip insertion hole 221 is open in one direction.

Clamp mechanism 220 is formed of a cylinder piston. Clamp mechanism 220 has a pair of pistons 226. The pair of pistons 226 extend in a shaft shape along a central axis 231 that is orthogonal to central axis 126 and intersects grip insertion hole 221. The pair of pistons 226 face, while being spaced apart from, each other in the axial direction of central axis 231. The pair of pistons 226 are slidably supported in the axial direction of central axis 126. A protrusion 227, which is engageable with groove portion 121, is provided at the tip of each piston 226.

When grip portion 120 is gripped by master hand 210, master hand 210 is positioned such that clamp mechanism 220 faces grip portion 120. Grip portion 120 is inserted into grip insertion hole 221 by moving master hand 210 linearly toward grip portion 120. Clamp mechanism 220 is operated from the unclamped state to the clamped state by sliding the pair of pistons 226 toward each other by supplying air pressure or the like. As a result, protrusions 227 of the pair of pistons 226 advance into grip insertion hole 221 and engage with groove portion 121.

When master hand 210 releases grip portion 120, clamp mechanism 220 is operated from the clamped state to the unclamped state by sliding the pair of pistons 226 away from each other. This causes protrusions 227 of the pair of pistons 226 to exit from grip insertion hole 221 and come out of groove portion 121. Grip portion 120 is removed from grip insertion hole 221 by linearly moving master hand 210 away from grip portion 120.

As shown in FIG. 5, transport system 100 further has a sensor 230. Sensor 230 can detect the presence or absence of an object, and is, for example, a non-contact photoelectric sensor. Sensor 230 may be a proximity sensor or a contact sensor such as a limit switch.

Sensor 230 is mounted in robot 21. Sensor 230 is mounted in master hand 210. When sensor 230 is a photoelectric sensor, the direction of emission of light from sensor 230 may be parallel to the direction in which grip portion 120 advances or exits to and from master hand 210.

Referring to FIG. 3, transport system 100 further has pallet 410 for holding a workpiece. Transport system 100 has a plurality of pallets 410.

Pallet 410 is formed of a metal plate member and has an approximately rectangular shape in top view. The table of machine tool 10 has a built-in clamp mechanism for gripping pallet 410. A jig such as an equerre or a clamping device is attached onto pallet 410, and a workpiece is held by pallet 410 with the jig in between.

Pallet 410 has a first grip portion 120A. First grip portion 120A corresponds to the above-described grip portion 120 and is configured to be gripped by master hand 210. First grip portion 120A is provided on the side surface of pallet 410. First grip portion 120A is detachably provided to pallet 410.

As master hand 210 grips first grip portion 120A, robot 21 can transport pallet 410.

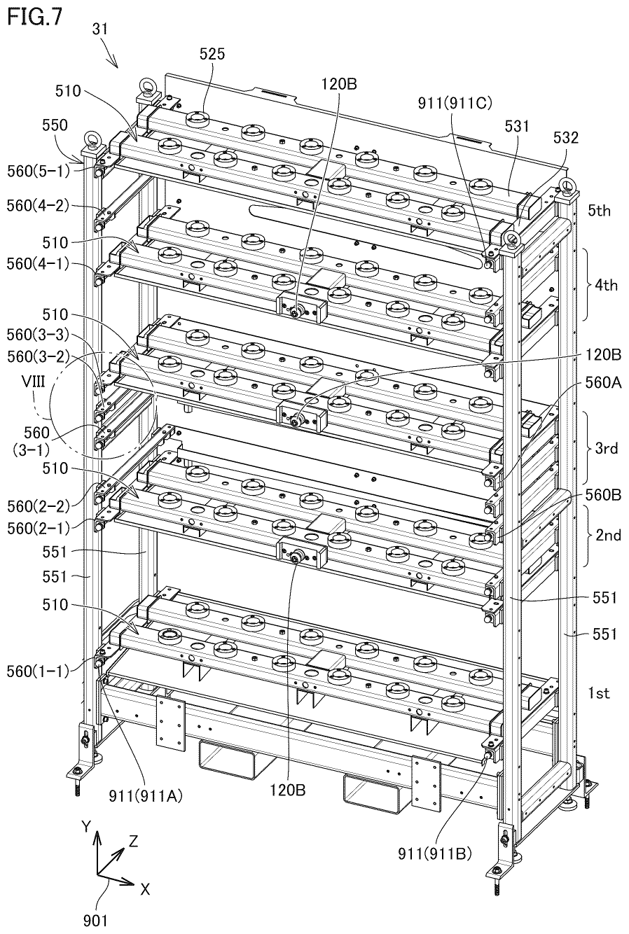

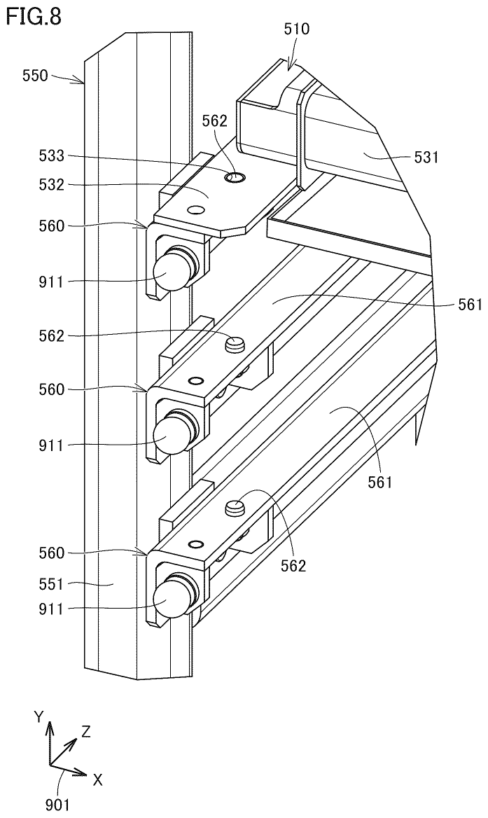

FIG. 7 is a perspective view of a pallet stocker in FIG. 1. FIG. 8 is a perspective view of the pallet stocker within the area enclosed by the chain double-dashed line VIII in FIG. 7.

In FIGS. 7 and 8, and in other figures showing pallet stocker 31, the X axis, Y axis, and Z axis, which are coordinate axes of pallet stocker 31, are shown. The X axis extends in the horizontal direction corresponding to the width direction (left-right direction) of pallet stocker 31, the Y axis extends in the upward-downward direction, and the Z axis extends in the horizontal direction corresponding to the depth direction (forward-backward direction) of pallet stocker 31. The X axis, the Y axis, and the Z axis are three axes orthogonal to one another.

Referring to FIGS. 3, 7, and 8, pallet stocker 31 has a frame body 550, a plurality of support portions 560, and a plurality of shelf plates 510.

Frame body 550 forms a frame body of rectangular parallelepiped shape. Frame body 550 forms a frame body of rectangular parallelepiped shape with each direction of the X-axis direction and Y-axis direction as the longer direction and the Z-axis direction as the shorter direction. Frame body 550 has four pillars 551. The four pillars 551 are disposed at the four corners of frame body 550 in top view. Each pillar 551 extends in the Y-axis direction (upward-downward direction).

Support portion 560 is configured so as to support shelf plate 510. The plurality of support portions 560 are provided side by side while being spaced apart from each other in the upward-downward direction.

Support portion 560 has a pair of plates 561 on the left and right. The pair of plates 561 are spaced apart from each other in the X-axis direction. Plate 561 extends in the Z-axis direction while having an L-shaped cross-sectional shape when being cut along the X-axis-Y-axis plane. The opposite ends of plate 561 in the Z-axis direction are respectively connected to two pillars 551 provided side by side in the Z-axis direction.

Shelf plate 510 is configured to allow pallet 410 to be placed thereon. Shelf plate 510 has a rectangular shape with the X-axis direction as the longer direction and the Z-axis direction as the shorter direction in top view, and has a plate shape with the Y-axis direction as the thickness direction.

Shelf plate 510 has a pair of vertical frames 532 on the left and right, and a pair of horizontal frames 531 in the front and back. The pair of vertical frames 532 are spaced apart from each other in the X-axis direction. The pair of vertical frames 532 are respectively provided at the opposite ends of shelf plate 510 in the X-axis direction. Vertical frame 532 is formed of a plate member with the Y-axis direction as its thickness direction, and extends in the Z-axis direction. The pair of horizontal frames 531 are spaced apart from each other in the Z-axis direction. Horizontal frame 531 extends in the X-axis direction and is connected to the pair of vertical frames 532 respectively at the opposite ends.

As shown in FIGS. 7 and 8, shelf plate 510 is supported by support portion 560. The pair of vertical frames 532 are placed on the pair of plates 561. The pair of vertical frames 532 bear the weight of shelf plate 510.

As shown in FIG. 8, support portion 560 further has a pin 562. Pin 562 is provided on plate 561. Pin 562 protrudes upward from the top surface of plate 561.

Vertical frame 532 has a pin hole 533. Pin hole 533 is a through hole that penetrates vertical frame 532 in the Y-axis direction. Pin 562 is disposed in pin hole 533. This configuration prevents shelf plate 510 from being misaligned with support portion 560.

As shown in FIG. 3, shelf plate 510 further has a plurality of pallet support portions 520 (520p, 520q, 520r).

Each pallet support portion 520 is configured so as to support pallet 410. Each pallet support portion 520 is formed of four tapered cone receiving portions 525 that are spaced apart from each other side by side in the X-axis direction and Z-axis direction. Tapered cone receiving portions 525 are provided on horizontal frame 531. Tapered cone receiving portions 525 protrude upward from the top surface of horizontal frame 531. Tapered cone receiving portion 525 has such a recessed shape as to receive a tapered cone provided on the bottom surface of pallet 410.

Pallet support portion 520p, pallet support portion 520q, and pallet support portion 520r are provided side by side in the stated order in the X-axis direction.

Shelf plates 510 are compatible with placement of pallets 410 of different sizes. For example, shelf plates 510 are compatible with placement of pallets 410 of a size of 400 mm by 400 mm and placement of pallets 410 of a size of 500 mm by 500 mm. When pallets 410 have the size of 400 mm by 400 mm, three pallets 410 can be placed on shelf plate 510 using pallet support portion 520p, pallet support portion 520q, and pallet support portion 520r. When pallet 410 has the size of 500 mm by 500 mm, two pallets 410 can be placed on shelf plate 510 using pallet support portion 520p and pallet support portion 520r.

As shown in FIGS. 3 and 7, shelf plate 510 has a second grip portion 120B. Second grip portion 120B corresponds to the above-described grip portion 120 and is configured to be gripped by master hand 210. Second grip portion 120B is provided at the center position of shelf plate 510 in the X-axis direction. Second grip portion 120B protrudes in the Z-axis direction from the front surface of shelf plate 510 (horizontal frame 531). Second grip portion 120B is provided below pallet support portion 520 (tapered cone receiving portion 525). Second grip portion 120B is detachably provided to shelf plate 510.

As master hand 210 grips second grip portion 120B, robot 21 can transport shelf plate 510. Robot 21 repositions shelf plate 510 between the plurality of support portions 560 in pallet stocker 31. The reposition of shelf plate 510 using robot 21 will be described later in detail.

Referring to FIG. 3, workpiece hand 310 is configured to grip workpiece W. Workpiece hand 310 has a pair of gripping claws 320. The pair of gripping claws 320 face, while being spaced apart from, each other.

Workpiece hand 310 is configured to be operable between a clamped state in which workpiece W is gripped by the pair of gripping claws 320 and an unclamped state in which the pair of gripping claws 320 release workpiece W. By sliding the pair of gripping claws 320 toward each other, workpiece hand 310 is operated from the unclamped state to the clamped state. By sliding the pair of gripping claws 320 away from each other, workpiece hand 310 is operated from the clamped state to the unclamped state.

Workpiece hand 310 has a piston cylinder 330 and a servomotor 340 as a power source for sliding the pair of gripping claws 320 (see FIG. 9, which will be referred to later).

Workpiece hand 310 further has a third grip portion 120C. Third grip portion 120C corresponds to the above-described grip portion 120 and is configured to be gripped by master hand 210. Third grip portion 120C has a grip shape extending in a direction orthogonal to the sliding direction of the pair of gripping claws 320. Third grip portion 120C is detachably provided to workpiece hand 310.

As master hand 210 grips third grip portion 120C, workpiece hand 310 can be attached to robot 21. Robot 21 can transport workpiece W using workpiece hand 310.

Teaching hand 710 has a touch probe 720. Teaching hand 710 is used for the teaching operation of robot 21 using touch probe 720.

Teaching hand 710 further has a fourth grip portion 120D. Fourth grip portion 120D corresponds to the above-described grip portion 120 and is configured to be gripped by master hand 210. Touch probe 720 has a pin-shaped contactor 720g that comes into contact with a measurement object. Fourth grip portion 120D has a grip shape extending in a direction orthogonal to the direction in which contactor 720g extends in a pin shape. Fourth grip portion 120D is detachably provided to teaching hand 710.

As master hand 210 grips fourth grip portion 120D, teaching hand 710 can be attached to robot 21.

First grip portion 120A, second grip portion 120B, third grip portion 120C, and fourth grip portion 120D have the same grip shape. Master hand 210 is configured to selectively grip any one grip portion 120 of first grip portion 120A, second grip portion 120B, third grip portion 120C, and fourth grip portion 120D.

FIG. 9 is a block diagram showing the control system of the transport system in FIG. 1. Referring to FIG. 9, transport system 100 further has a controller 610.

Each component of controller 610 is realized by hardware including a computing unit such as a central processing unit (CPU) and various computer processors, a storage device such as memory or storage, and wired or wireless communication lines that connect these, and software that is stored in the storage device and supplies processing commands to the computing unit. The computer programs that make up the software may be composed of a device driver, an operating system, various application programs that are located at higher layers of these, or a library that provides common functions to these programs. The computer programs may be recorded in a computer-readable storage medium or in a non-transitory computer-readable storage medium. The computer programs may be included in a computer program product. Each block described below indicates a functional unit block.

Controller 610 has an operation acceptance unit 660 and a robot control unit 620. Operation acceptance unit 660 accepts, for example, an operator's operation via display unit 670 (operation unit) including a touch panel display. Operation acceptance unit 660 outputs a signal corresponding to the operator's operation to robot control unit 620.

Robot control unit 620 controls the operations of robot 21 (including the operation of workpiece hand 310 attached to master hand 210).

Robot control unit 620 has a program storage unit 621, a program analysis unit 622, an axis control unit 623, a hand control unit 624, and a parameter storage unit 625.

Program storage unit 621 stores various operation programs 641 that command the operations of robot 21. Operation programs 641 stored in program storage unit 621 include, for example, an operation command that defines the movement and stop of robot 21, a position command that defines the position and orientation (posture) of master hand 210, a path command that defines the movement path for linear movement, circular movement, or any other movement, and a speed command that defines the movement speed. Operation program 641 is input via an input/output device 630 connected to robot control unit 620 and is stored in program storage unit 621.

Operation program 641 is written in, for example, a language called standard language for industrial manipulators (SLIM). The specific position and orientation (posture) in each position command included in operation program 641 are obtained by operating robot 21 through a manual operation called teaching operation. As robot 21 is operated by the teaching operation, the rotation angle position of each driving servomotor 23 built in robot 21 is acquired as a parameter, and the acquired parameter is stored in parameter storage unit 625 via input/output device 630.

Program analysis unit 622 reads operation program 641, which is stored in program storage unit 621 and is to be executed, in response to a signal from operation acceptance unit 660. Program analysis unit 622 analyzes operation program 641 to extract a command related to movement, and transmits the command to axis control unit 623. Program analysis unit 622 analyzes operation program 641 to extract a command related to the hand operation, and transmits the command to hand control unit 624.

Axis control unit 623 controls the plurality of driving servomotors 23 in response to the command from program analysis unit 622. Hand control unit 624 controls master hand 210 and/or workpiece hand 310 in response to the command from program analysis unit 622.

Specifically, axis control unit 623 reads a parameter corresponding to each position command from parameter storage unit 625, generates a rotation command (control signal) for each driving servomotor 23 such that the rotational angle position of each driving servomotor 23 becomes the read rotational angle position, that the movement path of master hand 210 becomes the commanded movement path (linear movement or circular movement), and that master hand 210 moves at the commanded speed, and transmits the generated rotation command to each driving servomotor 23. The plurality of driving servomotors 23 move master hand 210 to the commanded position by being supplied with a driving current in response to the rotation command from axis control unit 623.

Hand control unit 624 generates an open/close command for the air valve such that the pair of pistons 226 slide in response to the command from program analysis unit 622, and transmits the open/close command to clamp mechanism 220. Hand control unit 624 generates an open/close command for the air valve such that the pair of gripping claws 320 slide in response to the command from program analysis unit 622, and transmits the open/close command to piston cylinder 330, or generates a rotation command (control signal) for servomotor 340 and transmits the rotation command to servomotor 340.

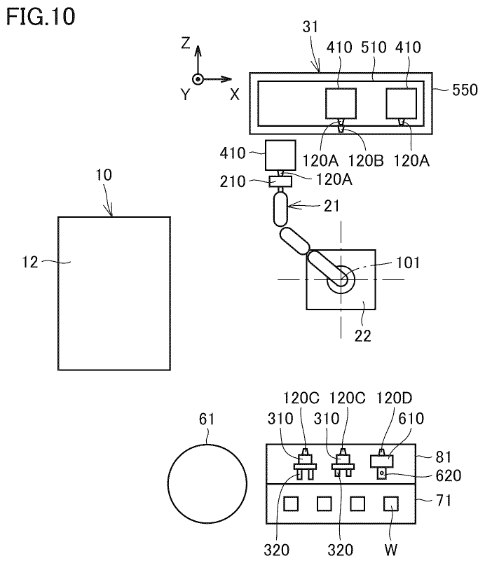

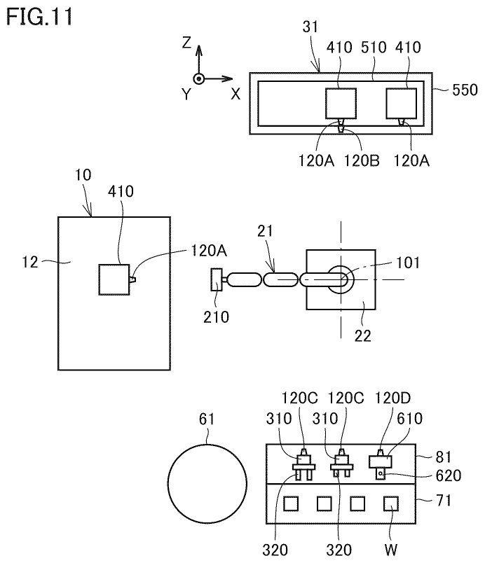

Next, a specific example of the manner of using robot 21 in transport system 100 will be described. FIGS. 10 to 15 are top views showing the steps of workpiece machining using a workpiece stocker. FIGS. 10 to 15 correspond to FIG. 2.

Referring to FIG. 2, in the initial state, a plurality of pallets 410 are stored in pallet stocker 31. The jig (not shown) such as an equerre or a clamp device is mounted on pallet 410. Workpieces W yet to be machined are stored in workpiece stocker 71. A plurality of workpiece hands 310 and teaching hand 710 are stored in hand stocker 81. Workpiece hand 310 may have a pair of gripping claws 320 having a shape or size different among the plurality of workpiece hands 310.

Referring to FIGS. 9 and 10, controller 610 (robot control unit 620) controls robot 21 such that master hand 210 grips first grip portion 120A of pallet 410 stored in pallet stocker 31.

In this step, master hand 210 moves toward pallet stocker 31 and is positioned in the Z-axis direction so as to face first grip portion 120A of pallet 410. First grip portion 120A is inserted into grip insertion hole 221 as master hand 210 moves in the Z-axis direction. Master hand 210 grips first grip portion 120A. Pallet 410 is lifted from shelf plate 510 as master hand 210 moves upward.

Referring to FIGS. 9 and 11, then, controller 610 (robot control unit 620) controls robot 21 such that pallet 410 gripped by master hand 210 moves to machining area 12 of machine tool 10.

In this step, master hand 210 enters machining area 12 and places pallet 410 on a table (not shown). Pallet 410 is held on the table by a clamp mechanism built in the table. Master hand 210 releases first grip portion 120A and exits from machining area 12.

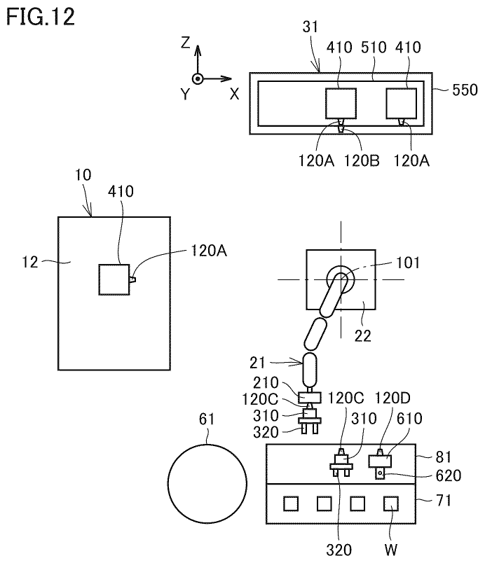

Referring to FIGS. 9 and 12, then, controller 610 (robot control unit 620) controls robot 21 such that master hand 210 grips third grip portion 120C of workpiece hand 310 stored in hand stocker 81.

In this step, master hand 210 moves toward hand stocker 81. Workpiece hand 310 is attached to robot 21 as master hand 210 grips third grip portion 120C.

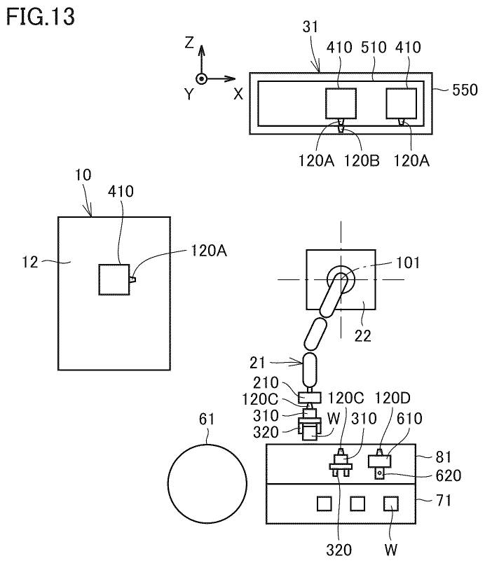

Referring to FIGS. 9 and 13, then, controller 610 (robot control unit 620) controls robot 21 and workpiece hand 310 such that workpiece hand 310 grips workpiece W.

In this step, workpiece hand 310 moves toward workpiece stocker 71. Workpiece hand 310 grips workpiece W yet to be machined.

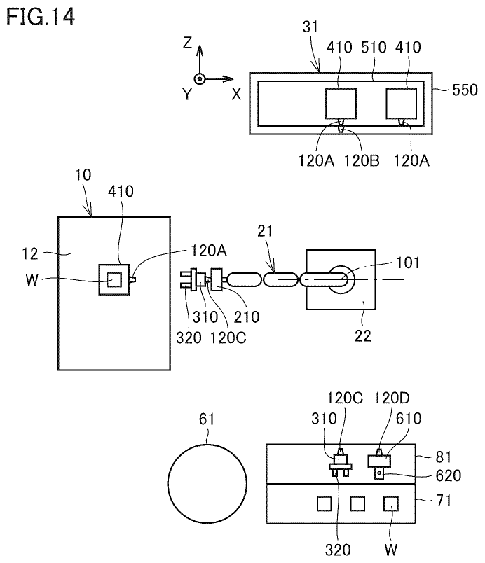

Referring to FIGS. 9 and 14, then, controller 610 (robot control unit 620) controls robot 21 and workpiece hand 310 such that workpiece W gripped by workpiece hand 310 is held by pallet 410 disposed in machining area 12 of machine tool 10.

In this step, workpiece hand 310 enters machining area 12 and disposes workpiece W on the jig on pallet 410. The jig holds workpiece W, and workpiece hand 310 releases workpiece W. Workpiece hand 310 exits from machining area 12. Subsequent to this step, machine tool 10 machines workpiece W in machining area 12.

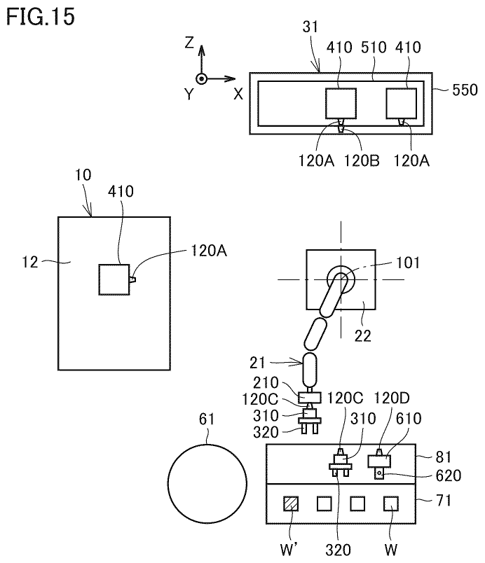

Referring to FIGS. 9 and 15, then, controller 610 (robot control unit 620) controls robot 21 and workpiece hand 310 such that a machined workpiece W′ is stored in workpiece stocker 71.

In this step, workpiece hand 310 enters machining area 12. Workpiece hand 310 grips machined workpiece W', and the jig on pallet 410 releases workpiece W′.

Workpiece hand 310 gripping workpiece W′ exits from machining area 12 and moves toward workpiece stocker 71. Workpiece hand 310 disposes workpiece W′ in workpiece stocker 71 and releases workpiece W′. The above steps complete the workpiece machining using workpiece stocker 71.

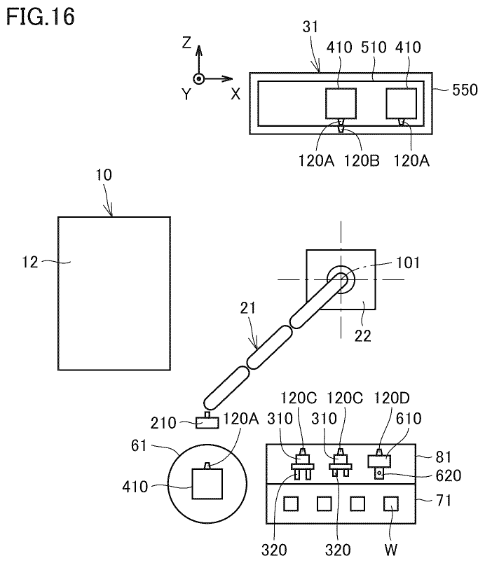

FIGS. 16 to 20 are top views showing the steps of workpiece machining using a setup station. FIGS. 16 to 20 correspond to FIG. 2.

Referring to FIG. 2, the initial state is similar to that of the workpiece machining using workpiece stocker 71 described above.

Referring to FIGS. 9 and 16, controller 610 (robot control unit 620) controls robot 21 such that master hand 210 grips first grip portion 120A of pallet 410 stored in pallet stocker 31. Controller 610 (robot control unit 620) controls robot 21 such that pallet 410 gripped by master hand 210 moves to setup station 61.

In this step, master hand 210 moves toward setup station 61 and places pallet 410 on a pallet placement base (not shown) installed in setup station 61. Master hand 210 releases first grip portion 120A. Master hand 210 exits from setup station 61.

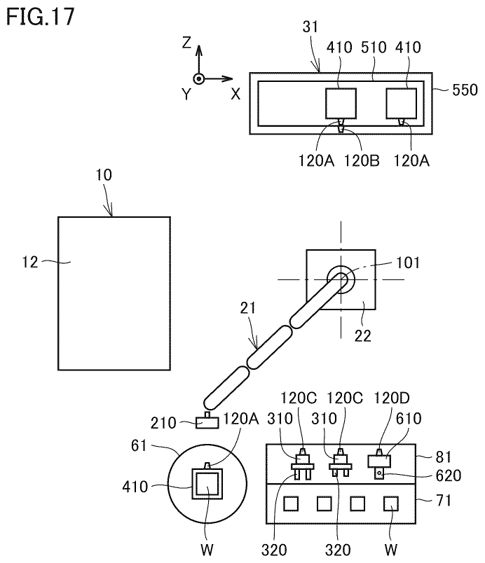

Referring to FIGS. 9 and 17, then, the operator sets workpiece W with respect to pallet 410. In this step, workpiece W yet to be machined is held with respect to pallet 410 using the jig on pallet 410.

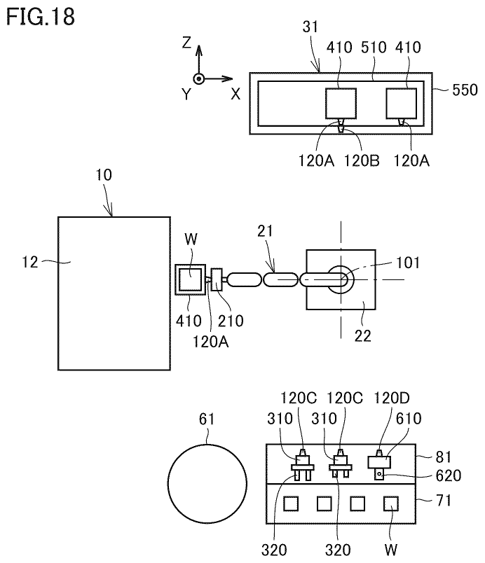

Referring to FIGS. 9 and 18, then, controller 610 (robot control unit 620) controls robot 21 such that master hand 210 grips first grip portion 120A of pallet 410 disposed in setup station 61.

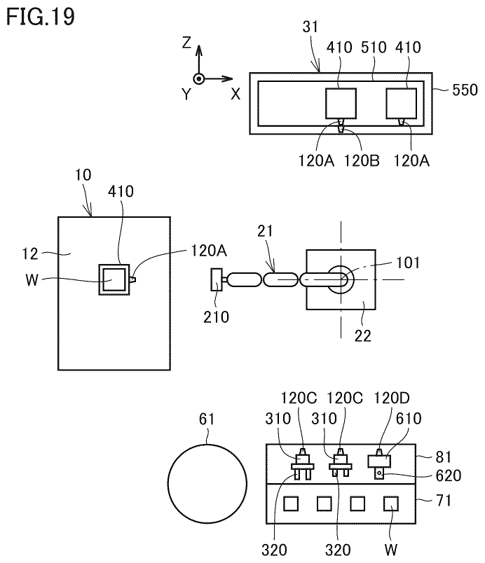

Referring to FIGS. 9 and 19, then, controller 610 (robot control unit 620) controls robot 21 such that pallet 410 gripped by master hand 210 moves to machining area 12. Subsequent to this step, machine tool 10 machines workpiece W in machining area 12.

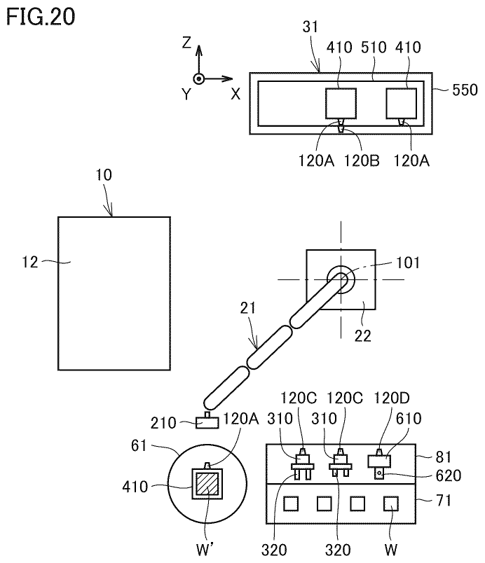

Referring to FIGS. 9 and 20, then, controller 610 (robot control unit 620) controls robot 21 such that master hand 210 grips first grip portion 120A of pallet 410 disposed in machining area 12. Controller 610 (robot control unit 620) controls robot 21 such that pallet 410 gripped by master hand 210 moves to setup station 61. Subsequent to this step, the operator removes the machined workpiece W′ from the jig on pallet 410. The above steps complete the workpiece machining using setup station 61.

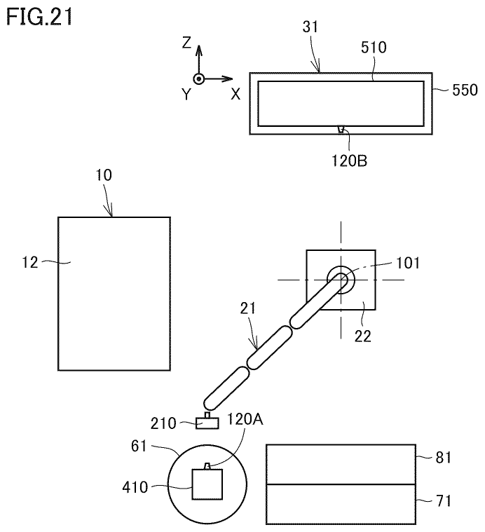

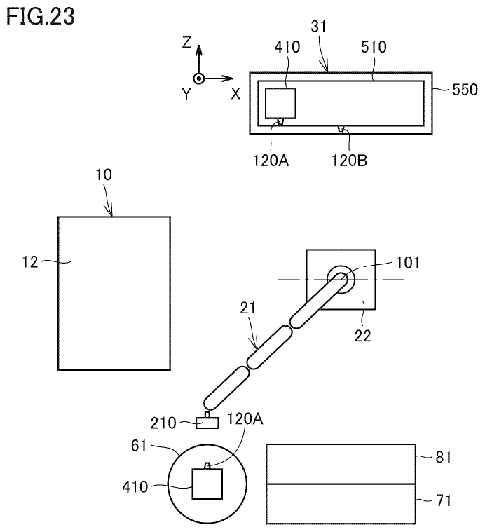

FIGS. 21 to 23 are top views showing the steps of loading a pallet to a pallet stocker. FIGS. 21 to 23 correspond to FIG. 2.

Referring to FIGS. 9 and 21, in the initial state, pallet 410 is not stored in pallet stocker 31. The operator places pallet 410 on the pallet placement base (not shown) in setup station 61.

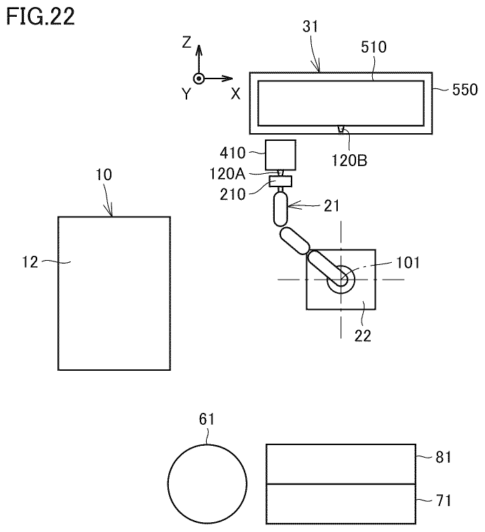

Referring to FIGS. 9 and 22, controller 610 (robot control unit 620) controls robot 21 such that master hand 210 grips first grip portion 120A of pallet 410 disposed in setup station 61. Controller 610 (robot control unit 620) controls robot 21 such that pallet 410 gripped by master hand 210 moves to pallet stocker 31.

Referring to FIGS. 9 and 22, then, controller 610 (robot control unit 620) controls robot 21 such that pallet 410 gripped by master hand 210 is placed on shelf plate 510.

By repeating the above steps, a plurality of pallets 410 can be loaded to pallet stocker 31.

Still another manner of using robot 21 in transport system 100 is reposition of shelf plates 510 in pallet stocker 31. Referring to FIG. 7, pallet stocker 31 has a multistage shelf structure including a plurality of floors, that is, “1st”, “2nd”, “3rd”, “4th”, and “5th”floors.

A support portion 560 (1-1) is provided on the lowermost floor indicated as “1st”, and a support portion 560 (5-1) is provided on the uppermost floor indicated as “5th”. Shelf plate 510 is disposed on each support portion 560 of support portion 560 (1-1) and support portion 560 (5-1). The respective shelf plates 510 supported by support portions 560, that is, support portion 560 (1-1) and support portion 560 (5-1), are of fixed type that does not allow reposition between the plurality of support portions 560.

On the floor second from the bottom, indicated as “2nd”, a support portion 560 (2-1) and a support portion 560 (2-2) are spaced apart from each other in the upward-downward direction. Robot 21 can move shelf plate 510 between support portion 560 (2-1) and support portion 560 (2-2).

On the middle floor indicated as “3rd”, a support portion 560 (3-1), a support portion 560 (3-2), and a support portion 560 (3-3) are spaced apart from each other in the upward-downward direction. Robot 21 can move shelf plate 510 among support portion 560 (3-1), support portion 560 (3-2), and support portion 560 (3-3).

On the floor second from the top, indicated as “4th”, a support portion 560 (4-1) and a support portion 560 (4-2) are spaced apart from each other in the upward-downward direction. Robot 21 can move shelf plate 510 between support portion 560 (4-1) and support portion 560 (4-2).

In the current arrangement of shelf plates 510, shelf plate 510 is supported by support portion 560 (2-1) on the “2nd” floor. On the “3rd” floor, shelf plate 510 is supported by support portion 560 (3-3). On the “4th” floor, shelf plate 510 is supported by support portion 560 (4-1).

Referring to FIGS. 7 and 9, the operator performs an operation for repositioning shelf plate 510 through display unit 670, which is, for example, a touch panel display. Operation acceptance unit 660 accepts an operator's operation and outputs a signal corresponding to the operation to program analysis unit 622. The signals output to program analysis unit 622 include a signal for determining the position before movement (first support portion 560A) and the position after movement (second support portion 560B) of shelf plate 510 to be repositioned.

Upon acceptance of a command to reposition shelf plate 510 from first support portion 560A to second support portion 560B among the plurality of support portions 560, robot control unit 620 (program analysis unit 622) controls robot 21 to move shelf plate 510 from first support portion 560A to second support portion 560B while gripping shelf plate 510 with master hand 210. In an example, when support portion 560 (3-3) corresponds to first support portion 560A and support portion 560 (3-1) corresponds to second support portion 560B, shelf plate 510 is transported by robot 21 to be repositioned from support portion 560 (3-3) to support portion 560 (3-1).

Through repositioning of shelf plate 510 in this manner, the maximum height of the workpiece that can be placed on pallet 410 on each floor of the “1st”, “2nd”, “3rd”, and “4th”floors can be freely adjusted.

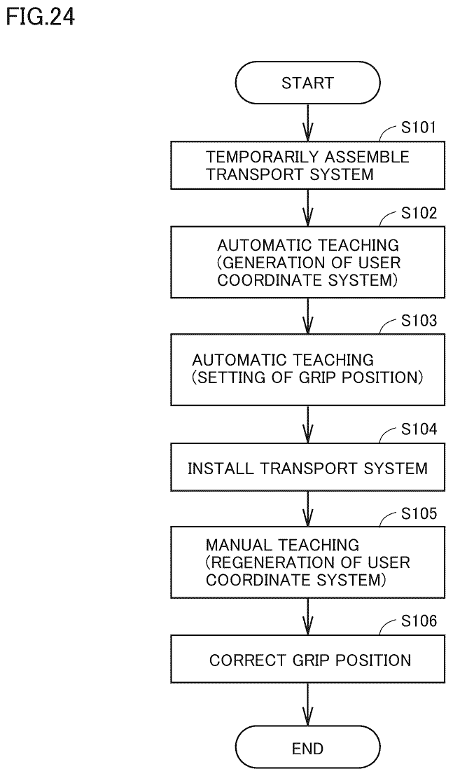

Next, a teaching operation of robot 21 will be described. FIG. 24 is a flowchart showing an overall flow of a teaching operation of a robot.

Referring to FIG. 24, a teaching operation is performed to determine the position of first grip portion 120A of each pallet 410 stored in pallet stocker 31 in order to allow master hand 210 to grip first grip portion 120A of pallet 410 stored in pallet stocker 31.

The overall flow of the teaching operation will be described. First, the operator temporarily assembles transport system 100 (S101).

In this step, the operator assembles robot 21 to robot base 22 in the assembly plant for transport system 100, and installs machine tool 10, pallet stocker 31, workpiece stocker 71, hand stocker 81, setup station 61, and the like around robot base 22.

Subsequently, automatic teaching is performed using robot 21 to generate a user coordinate system 901 for pallet stocker 31 (S102).

The user coordinate system is a coordinate system that can be defined by the user separately from the coordinate system (e.g., a world coordinate system with the center of robot base 22 as the origin) that serves as the reference for robot 21. The coordinate axes consisting of the three orthogonal axes, that is, X axis, Y axis, and Z axis described above (see FIG. 7), correspond to user coordinate system 901 defined for pallet stocker 31.

Subsequently, as automatic teaching by robot 21 is performed, the position of first grip portion 120A of each pallet 410 in user coordinate system 901 is set (S103). The position of first grip portion 120A set in this step is a specific position on the axis of the grip center of first grip portion 120A, and will be hereinafter referred to as the “grip position of first grip portion 120A”as well.

After automatic teaching performed in steps S102 and S103, transport system 100 is disassembled and shipped from the assembly plant to the user's plant or the like.

Subsequently, the operator installs transport system 100 (S104). In this step, the operator installs transport system 100 in the user's plant or the like.

Subsequently, the operator regenerates user coordinate system 901 for pallet stocker 31 through manual teaching (S105).

Through disassembly and reassembly of transport system 100 from the generation of user coordinate system 901 in the previous step S102, the positional relationship between robot base 22 and pallet stocker 31 changes, or the orientation of pallet stocker 31 changes. In this step, user coordinate system 901 corresponding to pallet stocker 31 after installation is regenerated.

Subsequently, the grip position of first grip portion 120A is corrected (S106) to correspond to user coordinate system 901 regenerated in step S105. The position of the origin and the direction of each axis of the X-axis, Y-axis, and Z-axis are different between user coordinate system 901 generated in step S102 and user coordinate system 901 regenerated in step S105. Thus, the grip position of first grip portion 120A is corrected to correspond to the regenerated user coordinate system 901.

Next, the structure of pallet stocker 31 used for automatic teaching in steps S102 and S103 of FIG. 24 will be described.

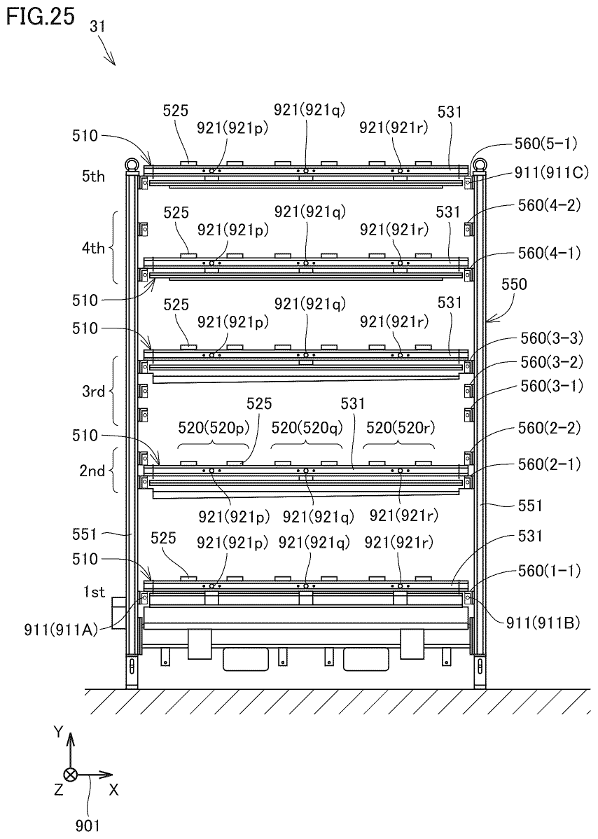

FIG. 25 is a front view of the pallet stocker during automatic teaching. Referring to FIG. 25, during automatic teaching in steps S102 and S103 of FIG. 24, a plurality of reference spheres 911 are attached to pallet stocker 31.

Reference sphere 911 includes a spherical portion. The plurality of reference spheres 911 are disposed at positions distant from one another. The plurality of reference spheres 911 are provided in the same plane (X-axis-Y-axis plane). The plurality of reference spheres 911 are provided on the front surface of pallet stocker 31 in the Z-axis direction.

The plurality of reference spheres 911 include a first reference sphere 911A, a second reference sphere 911B, and a third reference sphere 911C. First reference sphere 911A and second reference sphere 911B are spaced apart from each other in the X-axis direction. First reference sphere 911A and second reference sphere 911B are respectively attached to the opposite ends of support portion 560 (1-1) in the X-axis direction. Third reference sphere 911C is spaced apart from second reference sphere 911B in the Y-axis direction. Third reference sphere 911C is attached to one end of support portion 560 (5-1) in the X-axis direction.

Reference sphere 911 is detachably provided to pallet stocker 31. Reference sphere 911 is detachably provided to support portion 560. The plurality of reference spheres 911 may be removed from pallet stocker 31 after automatic teaching is complete.

During automatic teaching in steps S102 and S103 of FIG. 24, second grip portion 120B in FIG. 3 is not attached to shelf plate 510, and pallet 410 in FIG. 3 is not placed on shelf plate 510.

Shelf plate 510 has a plurality of reference holes 921 (921p, 921q, 921r).

Reference holes 921 are provided in horizontal frame 531. Reference hole 921 penetrates horizontal frame 531 in the Z-axis direction and forms a circular opening parallel to the X-axis-Y-axis plane. Reference hole 921 is provided in the front surface of pallet stocker 31 (horizontal frame 531) in the Z-axis direction. The plurality of reference holes 921 are spaced apart from one another in the Z-axis direction. The plurality of reference holes 921 are equidistantly spaced in the Z-axis direction.

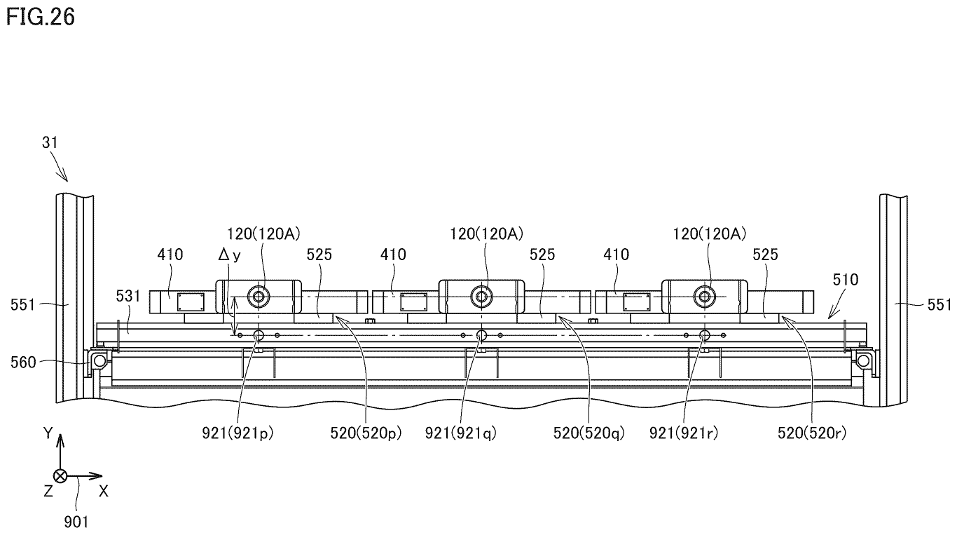

FIG. 26 is a front view showing the positional relationship between the reference hole and the first grip portion of the pallet stored in the workpiece stocker.

Referring to FIGS. 25 and 26, with pallet 410 being placed on shelf plate 510, a plurality of taper cones provided on the bottom surface of pallet 410 are received respectively by the plurality of taper cone receiving portions 525 provided in shelf plate 510. With this configuration, the positional relationship between reference hole 921 provided in shelf plate 510 and first grip portion 120A of pallet 410 placed on shelf plate 510 is mechanically determined.

More specifically, as viewed in the Z-axis direction, the grip position of first grip portion 120A is located directly above the opening center of reference hole 921. The X-axis coordinate of the opening center of reference hole 921 is the same as the X-axis coordinate of the grip position of first grip portion 120A, and the Y-axis coordinate of the grip position of first grip portion 120A is the value obtained by adding a constant value Ay to the Y-axis coordinate of the opening center of reference hole 921. The Z-axis coordinate of the opening center of reference hole 921 may be the same as the Z-axis coordinate of the grip position of first grip portion 120A, or may be a value shifted by a constant value.

In each shelf plate 510, reference hole 921p, reference hole 921q, and reference hole 921r are provided in correspondence with pallet support portion 520p, pallet support portion 520q, and pallet support portion 520r, respectively. Reference hole 921p and first grip portion 120A of pallet 410 supported by pallet support portion 520p satisfy the positional relationship described above, and reference hole 921q and first grip portion 120A of pallet 410 supported by pallet support portion 520q satisfy the positional relationship described above, and reference hole 921r and first grip portion 120A of pallet 410 supported by pallet support portion 520r satisfy the positional relationship described above.

First reference sphere 911A, second reference sphere 911B, and third reference sphere 911C are targets for measurement by touch probe 720 held by robot 21 during automatic teaching in step S102 of FIG. 24. The plurality of reference holes 921 are targets for measurement by touch probe 720 held by robot 21 during automatic teaching in step S103 of FIG. 24.

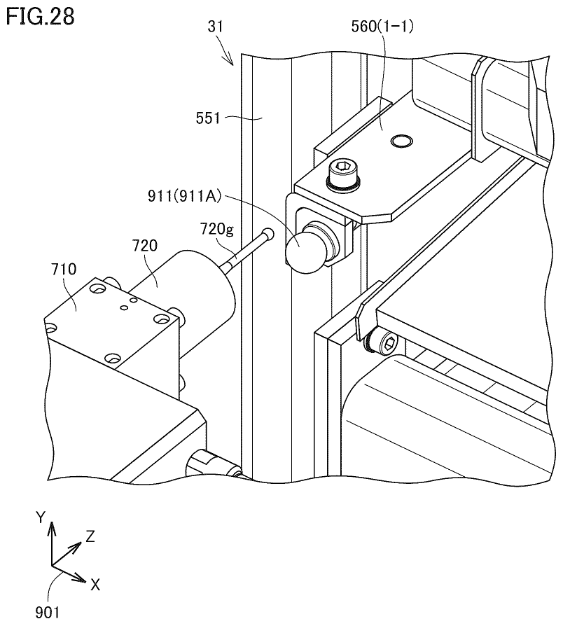

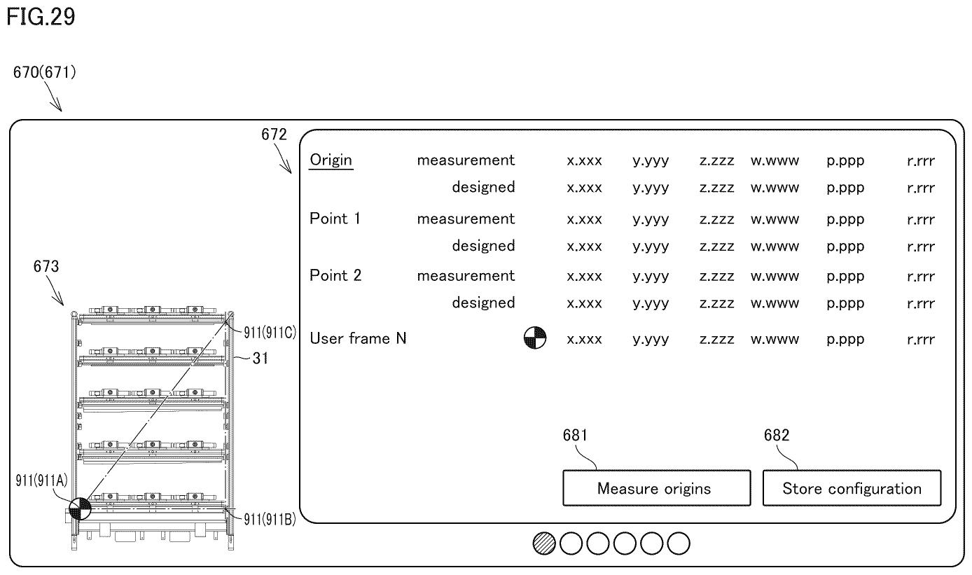

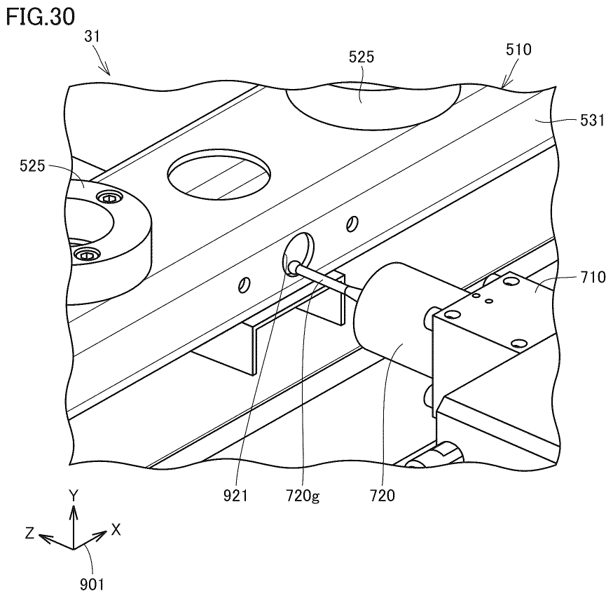

FIG. 27 is a block diagram showing the control system for automatic teaching. FIG. 28 is a perspective view showing how automatic teaching for generation of the user coordinate system is performed. FIG. 29 shows a user coordinate system generation screen on a display unit.

Referring to FIGS. 27 to 29, robot control unit 620 further has a pallet stocker positional relationship storage unit 627. Pallet stocker positional relationship storage unit 627 stores the positional relationship between the center position of reference hole 921 (the center position of the opening surface of reference hole 921) and the grip position of first grip portion 120A.

Program storage unit 621 stores various operation programs 641 that command operations of robot 21. Operation programs 641 include an operation program for automatic teaching 641Q. Operation program for automatic teaching 641Q commands an operation of robot 21 during automatic teaching.

Program analysis unit 622 accepts a command to start automatic teaching from a signal from operation acceptance unit 660 and reads operation program 641Q from program storage unit 621. Program analysis unit 622 analyzes operation program 641Q, extracts a command related to movement, and transmits the command to axis control unit 623. Program analysis unit 622 analyzes operation program 641Q, extracts a command related to an operation of master hand 210, and transmits the command to hand control unit 624.

Axis control unit 623 controls the plurality of driving servomotors 23 in response to the command from program analysis unit 622. Hand control unit 624 controls master hand 210 in response to the command from program analysis unit 622.

The following will describe a configuration for automatic teaching (generation of a user coordinate system) in step S102 of FIG. 24.

Robot control unit 620 operates robot 21 to detect the center positions of first reference sphere 911A, second reference sphere 911B, and third reference sphere 911C in pallet stocker 31, and generates user coordinate system 901 in pallet stocker 31 based on the center positions of first reference sphere 911A, second reference sphere 911B, and third reference sphere 911C.

More specifically, as shown in FIG. 28, robot control unit 620 operates robot 21 such that teaching hand 710 held by master hand 210 approaches first reference sphere 911A. Robot control unit 620 operates robot 21 such that contactor 720g of touch probe 720 comes into contact with a plurality of points (e.g., four points) distant from one another on the spherical surface of first reference sphere 911A. Touch probe 720 converts the position information of each point on the spherical surface of first reference sphere 911A into an electrical signal and outputs the signal to robot control unit 620.

Similarly, robot control unit 620 operates robot 21 such that contactor 720g of touch probe 720 comes into contact with a plurality of points distant from one another on the spherical surface of second reference sphere 911B. Touch probe 720 converts the position information of each point on the spherical surface of second reference sphere 911B into an electrical signal and outputs the signal to robot control unit 620. Robot control unit 620 operates robot 21 such that contactor 720g of touch probe 720 comes into contact with a plurality of points distant from one another on the spherical surface of third reference sphere 911C. Touch probe 720 converts the position information of each point on the spherical surface of third reference sphere 911C into an electrical signal and outputs the signal to robot control unit 620.

Robot control unit 620 further has a user coordinate system generation unit 637. User coordinate system generation unit 637 calculates the center position of first reference sphere 911A, the center position of second reference sphere 911B, and the center position of third reference sphere 911C based on the signals from touch probe 720.

User coordinate system generation unit 637 generates user coordinate system 901 composed of an X axis, which extends from the center position of first reference sphere 911A toward the center position of second reference sphere 911B, a Y axis, which extends from the center position of first reference sphere 911A, is orthogonal to the X axis, and is parallel to the plane connecting the center positions of first reference sphere 911A, second reference sphere 911B, and third reference sphere 911C, and a Z axis, which extends in the direction orthogonal to each axis of the X axis and the Y axis from the center position of first reference sphere 911A, with the center position of first reference sphere 911A as the origin.

User coordinate system generation unit 637 stores, in parameter storage unit 625, generated user coordinate system 901 in pallet stocker 31.

Controller 610 further has a display control unit 650. Display control unit 650 controls screen display on display unit 670.

The operator performs an operation to start the user coordinate system generation mode via display unit 670, which is a touch panel display. Operation acceptance unit 660 accepts an operator's operation and outputs a signal corresponding to the operation to display control unit 650. As a result, display control unit 650 causes display unit 670 to display a user coordinate system generation screen 671.

As shown in FIG. 29, user coordinate system generation screen 671 has a position information display unit 672 and a palette stocker image unit 673.

Position information display unit 672 displays the position information of the centers of first reference sphere 911A, second reference sphere 911B, and third reference sphere 911C, as well as the position information of the origin of user coordinate system 901.

The item “Origin” relates to the position information of first reference sphere 911A. The center of first reference sphere 911A is set at the origin of user coordinate system 901. The item “Point 1” relates to the position information of second reference sphere 911B, and the item “Point 2” relates to the position information of third reference sphere 911C. The item “measurement” displays the position information (coordinates and hand posture) of the center of each reference sphere 911 measured by touch probe 720. The item “designed” displays the design-based position information of the center of each reference sphere 911.

The item “User frame N” displays the position information of the origin of user coordinate system 901 generated by user coordinate system generation unit 637, using the coordinates of the world coordinate system.

Pallet stocker image unit 673 displays an image of pallet stocker 31 as viewed in the Z-axis direction, as well as the positions of first reference sphere 911A, second reference sphere 911B, and third reference sphere 911C in this image.

User coordinate system generation screen 671 further has a first operation unit 681 and a second operation unit 682. First operation unit 681 is configured such that, when operated by the operator, the measurement of first reference sphere 911A, second reference sphere 911B, and third reference sphere 911C by touch probe 720 is started. Second operation unit 682 is configured such that, when operated by the operator, the generated user coordinate system 901 is stored in parameter storage unit 625.

Next, the configuration for automatic teaching (grip position setting) in step S103 of FIG. 24 will be described.

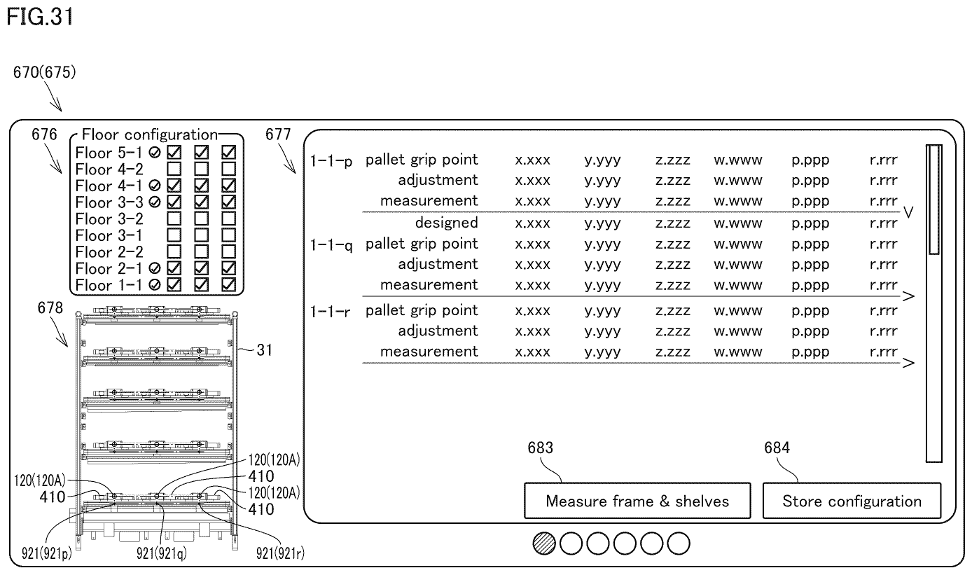

FIG. 30 is a perspective view showing how automatic teaching for grip position setting is performed. FIG. 31 shows a grip position setting screen on the display unit.

Referring to FIGS. 27, 30, and 31, in step $103 following step S102 of FIG. 24, robot control unit 620 operates robot 21 to detect the center position of reference hole 921 in shelf plate 510, and calculates the grip position of first grip portion 120A in user coordinate system 901 based on the detected center position of reference hole 921 and the positional relationship between reference hole 921 and first grip portion 120A with pallet 410 being placed on shelf plate 510.

More specifically, as shown in FIG. 30, robot control unit 620 operates robot 21 such that teaching hand 710 gripped by master hand 210 approaches reference hole 921. Robot control unit 620 operates robot 21 such that contactor 720g of touch probe 720 comes into contact with a plurality of points (e.g., four points) spaced apart from one another on the opening edge of reference hole 921. Touch probe 720 converts the position information of each point on the opening edge of reference hole 921 into an electrical signal and outputs the signal to robot control unit 620.

Robot control unit 620 further has a grip position calculation unit 636. Grip position calculation unit 636 calculates the center position of each reference hole 921 (the center position of the opening surface of reference hole 921) based on the signal from touch probe 720.

Grip position calculation unit 636 reads the positional relationship between the center position of reference hole 921 and the grip position of first grip portion 120A from pallet stocker positional relationship storage unit 627. Grip position calculation unit 636 calculates the grip position of first grip portion 120A based on the calculated center position of reference hole 921 and the positional relationship read from pallet stocker positional relationship storage unit 627.

Grip position calculation unit 636 stores the calculated grip position of first grip portion 120A in parameter storage unit 625.

Robot control unit 620 performs automatic teaching described above on reference hole 921p, reference hole 921q, and reference hole 921r in shelf plate 510 supported by each support portion 560 of support portion 560 (1-1), support portion 560 (2-1), support portion 560 (3-3), support portion 560 (4-1), and support portion 560 (5-1).

Robot control unit 620 moves shelf plate 510 from support portion 560 (2-1) to support portion 560 (2-2), and performs automatic teaching described above on reference hole 921p, reference hole 921q, and reference hole 921r in shelf plate 510 supported by support portion 560 (2-2).

Robot control unit 620 moves shelf plate 510 from support portion 560 (3-3) to each support portion 560 of support portion 560 (3-1) and support portion 560 (3-2), and performs automatic teaching described above on reference hole 921p, reference hole 921q, and reference hole 921r in shelf plate 510 supported by each support portion 560 of support portion 560 (3-1) and support portion 560 (3-2).

Robot control unit 620 moves shelf plate 510 from support portion 560 (4-1) to support portion 560 (4-2), and performs automatic teaching described above on reference hole 921p, reference hole 921q, and reference hole 921r in shelf plate 510 supported by support portion 560 (4-2).

As shown in FIG. 27, the operator performs an operation for starting the grip position setting mode via display unit 670, which is a touch panel display. Operation acceptance unit 660 accepts an operator's operation and outputs a signal corresponding to the operation to display control unit 650. As a result, display control unit 650 causes display unit 670 to display grip position setting screen 675.

As shown in FIG. 31, grip position setting screen 675 has a position information display unit 677, a pallet stocker image unit 678, and a progress display unit 676.

Position information display unit 677 displays the position information of the opening center of each reference hole 921 and the grip position information of each first grip portion 120A.

FIG. 31 shows, as a representative example, information related to shelf plate 510 supported by support portion 560 (1-1) and pallet 410 placed on shelf plate 510.

The items “1-1-p”, “1-1-q”, and “1-1-r” correspond to pallet support portion 520p, pallet support portion 520q, and pallet support portion 520r, respectively.

The item “measurement” displays the position information (coordinates and hand posture) of the opening center of each reference hole 921 measured by touch probe 720. The item “pallet grip point” displays the position information of the grip position of each first grip portion 120A calculated by grip position calculation unit 636. The item “adjustment” is configured to allow input of an adjustment value when the grip position of first grip portion 120A calculated by grip position calculation unit 636 is desired to be adjusted.

Pallet stocker image unit 678 displays an image of pallet stocker 31 as viewed in the Z-axis direction, as well as the positions of a plurality of reference holes 921 and a plurality of first grip portions 120A in this image.

Progress display unit 676 displays the progress of grip position setting of first grip portion 120A. When grip position setting of first grip portion 120A is complete, a check mark is put. Further, in progress display unit 676, a check mark is put to support portion 560 on which shelf plate 510 is disposed among the plurality of support portions 560.

Grip position setting screen 675 further has a third operation unit 683 and a fourth operation unit 684. Third operation unit 683 is configured such that, when operated by the operator, the measurement of reference hole 921 by touch probe 720 is started. Fourth operation unit 684 is configured such that, when operated by the operator, the calculated grip position of first grip portion 120A is stored in parameter storage unit 625.

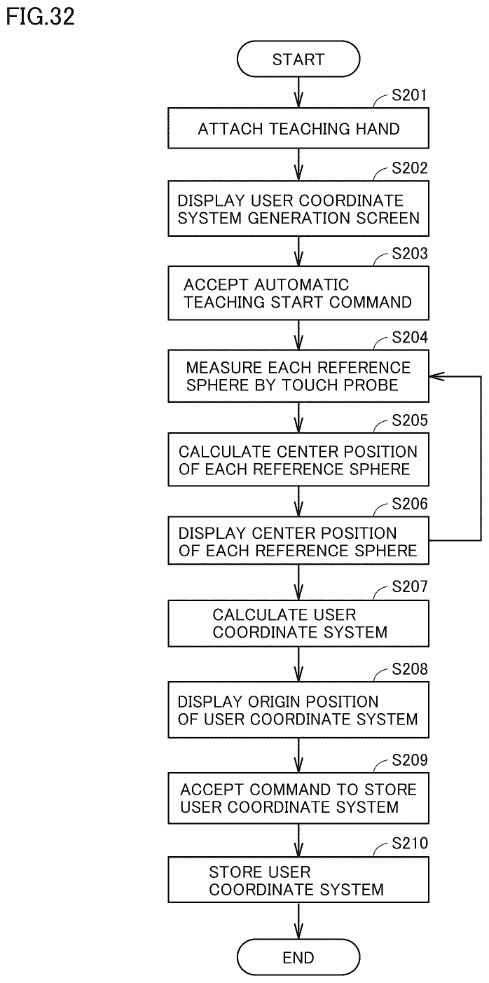

Next, a flow of steps of automatic teaching of robot 21 will be described. FIG. 32 is a flowchart showing a flow of the steps of automatic teaching for generation of the user coordinate system.

Referring to FIGS. 27 to 29 and 32, as a preliminary preparation for automatic teaching of robot 21, teaching hand 710 is attached to robot 21 (S201). In this step, master hand 210 grips fourth grip portion 120D of teaching hand 710 in FIG. 3.

Subsequently, when an operation is performed by the operator to start the user coordinate system generation mode, controller 610 (display control unit 650) causes display unit 670 to display user coordinate system generation screen 671 (S202).

Subsequently, controller 610 (robot control unit 620) accepts a command to start automatic teaching (S203).

In this step, the operator operates first operation unit 681 on user coordinate system generation screen 671, and operation acceptance unit 660 accepts the operation. Operation acceptance unit 660 outputs, to program analysis unit 622, a signal for starting the measurement of first reference sphere 911A, second reference sphere 911B, and third reference sphere 911C using touch probe 720.

Subsequently, controller 610 (robot control unit 620) controls robot 21 such that the measurement of first reference sphere 911A by touch probe 720 is performed (S204). Subsequently, controller 610 (robot control unit 620) calculates the center position of first reference sphere 911A (S205). In this step, user coordinate system generation unit 637 calculates the center position of first reference sphere 911A based on the signal from touch probe 720 and outputs the calculated center position of first reference sphere 911A to display control unit 650. Subsequently, controller 610 (display control unit 650) causes position information display unit 672 on user coordinate system generation screen 671 to display the center position information of first reference sphere 911A (S206).

Subsequently, controller 610 performs steps S204 to S206 described above on second reference sphere 911B. Subsequently, controller 610 performs steps S204 to S206 described above on third reference sphere 911C.

Subsequently, controller 610 (robot control unit 620) calculates user coordinate system 901 in pallet stocker 31 (S207).

In this step, user coordinate system generation unit 637 calculates user coordinate system 901 with the center position of first reference sphere 911A as the origin, based on the center position of first reference sphere 911A, the center position of second reference sphere 911B, and the center position of third reference sphere 911C. User coordinate system generation unit 637 outputs the calculated user coordinate system 901 to display control unit 650.

Subsequently, controller 610 (display control unit 650) causes position information display unit 672 on user coordinate system generation screen 671 to display the position information of the origin of user coordinate system 901 (S206).

Subsequently, controller 610 (robot control unit 620) accepts a command to store user coordinate system 901 (S209). In this step, the operator operates second operation unit 682 on user coordinate system generation screen 671, and operation acceptance unit 660 accepts the operation. Operation acceptance unit 660 outputs a signal for storing user coordinate system 901 to user coordinate system generation unit 637.

Subsequently, controller 610 (robot control unit 620) stores, in parameter storage unit 625, user coordinate system 901 in pallet stocker 31 (S210). Through the steps described above, automatic teaching for generating user coordinate system 901 is complete.

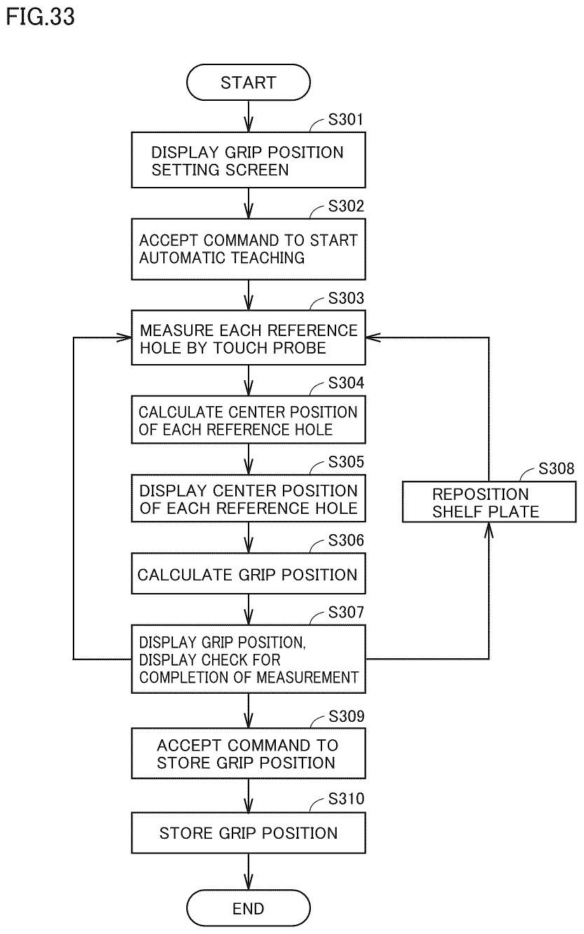

FIG. 33 is a flowchart showing a flow of the steps of automatic teaching for grip position setting.

Referring to FIGS. 27, 30, 31, and 33, when an operation is performed by the operator to start the grip position setting mode, controller 610 (display control unit 650) causes display unit 670 to display grip position setting screen 675 (S301).

Subsequently, controller 610 (robot control unit 620) accepts an automatic teaching start command (S302).

In this step, the operator operates third operation unit 683 on grip position setting screen 675, and operation acceptance unit 660 accepts the operation. Operation acceptance unit 660 outputs, to program analysis unit 622, a signal for starting the measurement of reference hole 921 using touch probe 720.

Subsequently, controller 610 (robot control unit 620) controls robot 21 such that the measurement of reference hole 921 using touch probe 720 is performed (S303). Subsequently, controller 610 (robot control unit 620) calculates the center position of reference hole 921 (S304). In this step, grip position calculation unit 636 calculates the center position of reference hole 921 based on the signal from touch probe 720 and outputs the calculated center position of reference hole 921 to display control unit 650. Subsequently, controller 610 (display control unit 650) causes position information display unit 677 on grip position setting screen 675 to display the position information of the opening center of reference hole 921 (S305).

Subsequently, controller 610 (robot control unit 620) calculates the grip position of first grip portion 120A in pallet 410 (S306). In this step, grip position calculation unit 636 calculates the grip position of first grip portion 120A based on the center position of reference hole 921 calculated in step S305, and the positional relationship between the center position of reference hole 921 read from pallet stocker positional relationship storage unit 627 and the grip position of first grip portion 120A. Grip position calculation unit 636 outputs the calculated grip position of first grip portion 120A to display control unit 650.

Subsequently, controller 610 (display control unit 650) causes position information display unit 677 on grip position setting screen 675 to display the grip position information of first grip portion 120A. Controller 610 (display control unit 650) causes a check mark to be displayed in the column corresponding to the calculated first grip portion 120A, which is progress display unit 676 on grip position setting screen 675 (S307).

Controller 610 performs steps S303 to S307 described above on reference hole 921p, reference hole 921q, and reference hole 921r in shelf plate 510 supported by each support portion 560 of support portion 560 (1-1), support portion 560 (2-1), support portion 560 (3-3), support portion 560 (4-1), and support portion 560 (5-1).

Subsequently, controller 610 (robot control unit 620) controls robot 21 such that shelf plate 510 moves from support portion 560 (2-1) to support portion 560 (2-2) (S308). Subsequently, controller 610 performs steps S303 to S307 described above on reference hole 921p, reference hole 921q, and reference hole 921r in shelf plate 510 supported by support portion 560 (2-2).

Similarly, controller 610 (robot control unit 620) controls robot 21 such that shelf plate 510 moves from support portion 560 (3-3) to each support portion 560 of support portion 560 (3-1) and support portion 560 (3-2) (S308). Subsequently, controller 610 performs steps S303 to S307 described above on reference hole 921p, reference hole 921q, and reference hole 921r in shelf plate 510 supported by each support portion 560 of support portion 560 (3-1) and support portion 560 (3-2).

Controller 610 (robot control unit 620) controls robot 21 such that shelf plate 510 moves from support portion 560 (4-1) to support portion 560 (4-2) (S308). Subsequently, controller 610 performs steps S303 to S307 described above on reference hole 921p, reference hole 921q, and reference hole 921r in shelf plate 510 supported by support portion 560 (4-2). Through the steps described above, a check mark indicating completion of grip position setting is put to all columns for first grip portion 120A in progress display unit 676.

Subsequently, controller 610 (robot control unit 620) accepts a command to store a grip position of first grip portion 120A (S309). In this step, the operator operates fourth operation unit 684 on grip position setting screen 675, and operation acceptance unit 660 accepts the operation. Operation acceptance unit 660 outputs a signal for storing a grip position to user coordinate system generation unit 637.

Subsequently, controller 610 (robot control unit 620) stores the grip position of first grip portion 120A in parameter storage unit 625 (S210). Through the steps described above, automatic teaching for grip position setting of first grip portion 120A is complete.

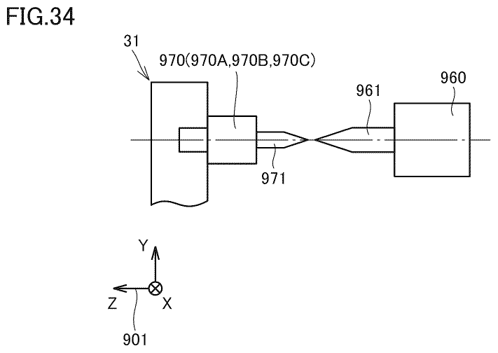

Next, manual teaching in step S105 of FIG. 24 will be described. FIG. 34 is a side view showing how manual teaching is performed.

Referring to FIG. 34, pallet stocker 31 has a plurality of jigs 970 (970A, 970B, 970C). Each jig 970 has a pin portion 971. Pin portion 971 extends in the Z-axis direction.

The plurality of jigs 970 are detachably provided to pallet stocker 31. In step S105 of FIG. 24, first jig 970A and second jig 970B are attached to the opposite ends of support portion 560 (1-1) in the X-axis direction, in place of first reference sphere 911A and second reference sphere 911B in FIG. 7, respectively. Third jig 970C is attached to one end of support portion 560 (5-1) in the X-axis direction, in place of third reference sphere 911C in FIG. 7.

During manual teaching in step S105 of FIG. 24, the operator attaches a hand-side jig 960 having a pin portion 961 to robot 21. The operator uses a teaching pendant to operate robot 21 such that the tip of pin portion 961 sequentially comes into contact with the tips of pin portions 971 of first jig 970A, second jig 970B, and third jig 970C. This determines the position of the tip of pin portion 971 of each jig 970.

User coordinate system generation unit 637 regenerates user coordinate system 901 in pallet stocker 31 based on the positions of the tips of pin portions 971 of first jig 970A, second jig 970B, and third jig 970C. User coordinate system generation unit 637 stores, in parameter storage unit 625, the regenerated user coordinate system 901 in pallet stocker 31.

In step S106 of FIG. 24, grip position calculation unit 636 corrects the grip position of first grip portion 120A such that the grip position corresponds to the regenerated user coordinate system 901. Grip position calculation unit 636 stores the corrected grip position of first grip portion 120A in parameter storage unit 625.

Summarizing the configuration of transport system 100 according to the embodiment of the present invention described above, transport system 100 in the present embodiment includes: pallet stocker 31 for storing pallet 410, pallet stocker 31 having shelf plate 510 on which pallet 410 is placed; robot 21 having master hand 210, which is a hand, capable of gripping first grip portion 120A, which is a grip portion of pallet 410; and robot control unit 620 that controls robot 21. Robot control unit 620 operates robot 21 to detect center positions of first reference sphere 911A, second reference sphere 911B, and third reference sphere 911C, which are the positions of three portions of pallet stocker 31 distant from one another, and generates user coordinate system 901 in pallet stocker 31 based on the detected center positions of first reference sphere 911A, second reference sphere 911B, and third reference sphere 911C. Robot control unit 620 operates robot 21 to detect a center position of reference hole 921, which is the position of a specific portion, of shelf plate 510, and calculates a position of first grip portion 120A in user coordinate system 901 based on the detected center position of reference hole 921, and the positional relationship between the center position of reference hole 921 and first grip portion 120A with pallet 410 being placed on shelf plate 510.

With this configuration, the labor required for the teaching operation of robot 21 can be reduced compared when pallet 410 is placed on shelf plate 510 and the position of first grip portion 120A of pallet 410 is directly detected.

Further, when regenerating user coordinate system 901 in pallet stocker 31, robot control unit 620 corrects the position of first grip portion 120A such that the position corresponds to the regenerated user coordinate system 901.

With this configuration, during the temporary assembly of transport system 100 in an assembly plant or the like, user coordinate system 901 in pallet stocker 31 is generated, and the position of first grip portion 120A in this user coordinate system 901 is calculated, thereby predetermining the position of first grip portion 120A in the system of pallet stocker 31. Then, during the installation of transport system 100 by the user in the plant or the like, user coordinate system 901 of pallet stocker 31 corresponding to the assembled state in installation is regenerated, and the position of first grip portion 120A is corrected so as to correspond to the regenerated user coordinate system 901. This can reduce the labor required for the teaching operation during the installation of transport system 100.

Pallet stocker 31 further includes a plurality of support portions 560 spaced apart from each other in the upward-downward direction, each of which is capable of supporting shelf plate 510. Robot control unit 620 accepts a command to reposition shelf plate 510 from first support portion 560A to second support portion 560B among the plurality of support portions 560, and in response to the command, controls robot 21 to move shelf plate 510 from first support portion 560A to second support portion 560B while gripping shelf plate 510 with master hand 210.

With this configuration, since the position of shelf plate 510 is variable, the number of positions of first grip portions 120A to be determined increases. Thus, the effect of reducing the labor required for the teaching operation of robot 21 is achieved more effectively.

Further, transport system 100 further includes display unit 670, and display control unit 650 that causes display unit 670 to display the center position of first reference sphere 911A, which is the position of the origin, in user coordinate system 901 generated by robot control unit 620, and the position of first grip portion 120A calculated by robot control unit 620.

With this configuration, the operator can check, via the display unit, the result of the position detection performed by automatic teaching.

Further, the automatic teaching method in the present embodiment includes: operating robot 21 to detect center positions of first reference sphere 911A, second reference sphere 911B, and third reference sphere 911C, which are the positions of three portions of pallet stocker 31, distant from one another, and generating user coordinate system 901 in pallet stocker 31 based on the detected center positions of first reference sphere 911A, second reference sphere 911B, and third reference sphere 911C (steps S201 to S210); and operating robot 21 to detect the center position of reference hole 921, which is the position of a specific portion, of shelf plate 510, and calculating a position of first grip portion 120A in user coordinate system 901 based on the detected center position of reference hole 921, and a positional relationship between the center position of reference hole 921 and first grip portion 120A with pallet 410 being placed on shelf plate 510 (steps S301 to S310).

With this configuration, the labor required for the teaching operation of robot 21 can be reduced.

A robot controller in the present embodiment controls a robot for transporting a pallet to a pallet stocker. The robot has a hand capable of gripping a grip portion of the pallet. The pallet stocker has a shelf plate on which the pallet is placed, and a plurality of support portions spaced apart from each other in an upward-downward direction, each support portion being capable of supporting the shelf plate. The robot controller includes: a user coordinate system generation unit that operates the robot to detect positions of three portions of the pallet stocker distant from one another and generates a user coordinate system in the pallet stocker based on the detected positions of the three portions; and a position calculation unit that operates the robot to detect a position of a specific portion of the shelf plate and calculates a position of the grip portion in the user coordinate system based on the detected position of the specific portion and a positional relationship between the specific portion and the grip portion with the pallet being placed on the shelf plate. The robot controller receives a command to reposition the shelf plate from a first support portion to a second support portion among the plurality of support portions, and in response to the command, controls the robot to move the shelf plate from the first support portion to the second support portion while gripping the shelf plate with the hand.

When the user coordinate system in the pallet stocker is regenerated by the user coordinate system generation unit, the position calculation unit corrects the position of the grip portion such that the position corresponds to the regenerated user coordinate system.

The robot control unit further includes a display control unit that causes the display unit to display a position of an origin in the generated user coordinate system and the calculated position of the grip portion.

A robot control method in the present embodiment is a method of controlling a robot for a transporting a pallet to a pallet stocker. The robot has a hand capable of gripping a grip portion of the pallet. The pallet stocker has a shelf plate on which the pallet is placed, and a plurality of support portions spaced apart from each other in an upward-downward direction, each support portion being capable of supporting the shelf plate. The robot control method includes: operating the robot to detect positions of three portions of the pallet stocker distant from one another and generating a user coordinate system in the pallet stocker based on the detected positions of the three portions; operating the robot to detect a position of a specific portion of the shelf plate and calculating a position of the grip portion in the user coordinate system based on the detected position of the specific portion and a positional relationship between the specific portion and the grip portion with the pallet being placed on the shelf plate; and accepting a command to reposition the shelf plate from the first support portion to the second support portion among the plurality of support portions, and in response to the command, controlling the robot to move the shelf plate from the first support portion to the second support portion while gripping the shelf plate with the hand.

It should be understood that the embodiment disclosed herein has been presented for the purpose of illustration and non-restrictive in every respect. It is therefore intended that the scope of the present invention is defined by claims, rather than the description above, and encompasses all modifications and variations equivalent in meaning and scope to the claims.

What is claimed is:

1. A transport system comprising:
a pallet stocker for storing a pallet, the pallet stocker having a shelf plate on which the pallet is placed;
a robot having a hand that grips a grip portion of the pallet, the robot transporting the pallet; and
a robot control unit that controls the robot,
wherein the robot control unit
operates the robot to detect positions of three portions of the pallet stocker distant from one another and generates a user coordinate system in the pallet stocker based on the detected positions of the three portions, and
operates the robot to detect a position of a specific portion of the shelf plate and calculates a position of the grip portion in the user coordinate system based on the detected position of the specific portion and a positional relationship between the specific portion and the grip portion with the pallet being placed on the shelf plate.

2. The transport system according to claim 1, wherein when regenerating the user coordinate system in the pallet stocker, the robot control unit corrects the position of the grip portion such that the position corresponds to the regenerated user coordinate system.

3. The transport system according to claim 1, wherein
the pallet stocker further includes a plurality of support portions spaced apart from each other in an upward-downward direction, each support portion supporting the shelf plate, and
the robot control unit accepts a command to rearrange the shelf plate from a first support portion to a second support portion among the plurality of support portions, and in response to the command, controls the robot to move the shelf plate from the first support portion to the second support portion while gripping the shelf plate with the hand.

4. The transport system according to claim 1, further comprising:
a display unit; and
a display control unit that causes the display unit to display a position of an origin in the user coordinate system generated by the robot control unit and the position of the grip portion calculated by the robot control unit.

5. An automatic teaching method in a transport system,
the transport system including
a pallet stocker for storing a pallet, the pallet stocker having a shelf plate on which the pallet is placed, and
a robot having a hand that grips a grip portion of the pallet, the robot transporting the pallet,
the automatic teaching method comprising:
operating the robot to detect positions of three portions of the pallet stocker distant from one another and generating a user coordinate system in the pallet stocker based on the detected positions of the three portions; and
operating the robot to detect a position of a specific portion of the shelf plate and calculating a position of the grip portion in the user coordinate system based on the detected position of the specific portion and a positional relationship between the specific portion and the grip portion with the pallet being placed on the shelf plate.
